(19) United States
(12) Patent Application Publication
(10) Pub. No.: US 2025/0187356 A1
(43) Pub. Date: Jun. 12, 2025

(54) INKJET RECORDING APPARATUS

(71) Applicant: CANON KABUSHIKI KAISHA, Tokyo (JP)

(72) Inventor: SHUICHI TAKENAKA, Chiba (JP)

(21) Appl. No.: 18/938,473

(22) Filed: Nov. 6, 2024

(30) Foreign Application Priority Data
Dec. 8, 2023 (JP) 2023-207614

(51) Int. Cl. B41J 13/00; B41J 11/00; B41J 13/10

(52) U.S. Cl. CPC B41J 13/0036; B41J 11/0095; B41J 13/0045; B41J 13/0054; B41J 13/106

(57) ABSTRACT

An inkjet recording apparatus controls a conveying portion such that a sheet detected by a detector passes through an ink head portion without forming an image and is discharged to a second stack tray, and control the conveying portion such that a subsequent sheet that is fed by a feeding portion and follows the sheet detected by the detector is discharged to a first stack tray without passing through the ink head portion, based on a detection result of the detector.

### BACKGROUND OF THE INVENTION

### Field of the Invention

The present invention relates to an inkjet recording apparatus that forms an image on a sheet.

### Description of the Related Art

Hitherto, an inkjet type image forming apparatus that ejects ink onto a recording medium such as a sheet to print an image includes a recording head unit including an inkjet head that ejects the ink in an image forming portion. The inkjet head of the recording head unit is a precision part that requires precise control, and is disposed close to a recording side of the recording medium to execute image forming processing.

In such an inkjet type image forming apparatus, in a case where the inkjet head comes into contact with the recording medium where uplift has occurred, the inkjet head may be damaged. Therefore, the inkjet type image forming apparatus needs to remove the recording medium where the uplift has occurred without damaging the inkjet head and resume a job to perform error recovery.

Japanese Patent Application Laid-Open No. 2021-66129 discloses an inkjet recording apparatus that protects an inkjet head from a recording medium where uplift has occurred. The inkjet recording apparatus of Japanese Patent Application Laid-Open No. 2021-66129 immediately retracts an inkjet head portion from a conveyance path when the recording medium where the uplift has occurred is detected, thereby avoiding damage of the inkjet head due to contact between the recording medium where the uplift has occurred and the inkjet head. However, Japanese Patent Application Laid-Open No. 2021-66129 does not disclose how to perform error recovery by discharging the recording medium where the uplift has occurred after retracting the inkjet head.

On the other hand, Japanese Patent Application Laid-Open No. 2004-20650 discloses an error recovery method at the time of detection of an abnormal sheet. In a case where inspection processing is executed on a sheet after image formation and an abnormal sheet is detected, an image forming apparatus of Japanese Patent Application Laid-Open No. 2004-20650 stores the detected abnormal sheet in a predetermined abnormal sheet storage portion and temporarily stores a normal sheet subsequent to the abnormal sheet in a predetermined normal sheet storage portion.

Further, when the storage of each sheet is completed, the image forming apparatus of Japanese Patent Application Laid-Open No. 2004-20650 starts feeding an additional sheet from a sheet tray, and forms an image scheduled to be printed on the abnormal sheet on the fed additional sheet. Then, when image forming processing on the additional sheet is completed, the image forming apparatus of Japanese Patent Application Laid-Open No. 2004-20650 starts feeding the normal sheet from the normal sheet storage portion again, and performs error recovery according to an order of sheet discharge.

However, in Japanese Patent Application Laid-Open No. 2004-20650, error recovery processing cannot be started until discharge of the abnormal sheet to an abnormal sheet storage portion and discharge of the normal sheet to the normal sheet storage portion are completed, and thus, there is a problem that a downtime increases. Such a problem is particularly remarkable in an image forming apparatus having a long distance to a sheet discharge destination, such as a large apparatus for commercial printing.

### SUMMARY OF THE INVENTION

It is desirable to provide an inkjet recording apparatus capable of reducing a downtime for discharging and temporarily retracting a subsequent sheet following a detected sheet when an abnormality of the sheet before image formation is detected.

An inkjet recording apparatus according to the present invention includes: an accommodating portion configured to accommodate a sheet; a feeding portion configured to feed the sheet accommodated in the accommodating portion; a conveying portion configured to convey the sheet fed by the feeding portion; an ink head portion configured to eject ink onto the sheet conveyed by the conveying portion to form an image; a detector provided downstream of the feeding portion and upstream of the ink head portion in a conveyance direction of the sheet and configured to detect the sheet; a first stack tray provided upstream of the detector in the conveyance direction and on which the sheet conveyed by the conveying portion is stacked; a second stack tray provided downstream of the ink head portion in the conveyance direction and on which the sheet conveyed by the conveying portion is stacked; and a controller configured to control the conveying portion such that the sheet detected by the detector passes through the ink head portion without forming the image and is discharged to the second stack tray, and control the conveying portion such that a subsequent sheet that is fed by the feeding portion and follows the sheet detected by the detector is discharged to the first stack tray without passing through the ink head portion, based on a detection result of the detector.

Further features of the present invention will become apparent from the following description of exemplary embodiments with reference to the attached drawings.

### BRIEF DESCRIPTION OF THE DRAWINGS

FIGS. 1A and 1B are a schematic view and a diagram of an image forming apparatus according to a first embodiment of the present invention;

FIGS. 2A to 2C are schematic views of a printing portion of the image forming apparatus according to the first embodiment of the present invention;

FIG. 3 is a block diagram illustrating a hardware configuration of the image forming apparatus according to the first embodiment of the present invention;

FIG. 4 is a schematic diagram illustrating a configuration of a software module of the image forming apparatus according to the first embodiment of the present invention;

FIG. 5 is a schematic view of a state of the image forming apparatus according to the first embodiment of the present invention immediately before detection of a misfed sheet during single-sided printing;

FIG. 6 is a schematic view of a state of the image forming apparatus according to the first embodiment of the present invention immediately after the misfed sheet is discharged during the single-sided printing;

FIG. 7 is a schematic view of a state of the image forming apparatus according to the first embodiment of the present invention in which all sheets are discharged to sheet discharge destinations during the single-sided printing;

FIG. 8 is a schematic view of a state of the image forming apparatus according to the first embodiment of the present invention in which some of the sheets during the single-sided printing are discharged to the sheet discharge destinations different from those in FIG. 7;

FIG. 9 is a schematic view of a state of the image forming apparatus according to the first embodiment of the present invention in which some of the sheets during the single-sided printing are discharged to the sheet discharge destinations different from those in FIGS. 7 and 8;

FIG. 10 is a schematic view of a state of the image forming apparatus according to the first embodiment of the present invention immediately before detection of the misfed sheet during double-sided printing;

FIG. 11 is a schematic view of a state of the image forming apparatus according to the first embodiment of the present invention immediately after the misfed sheet is discharged during the double-sided printing;

FIG. 12 is a schematic view of a state of the image forming apparatus according to the first embodiment of the present invention in which all sheets are discharged to sheet discharge destinations during the double-sided printing;

FIG. 13 is a schematic view of a state of the image forming apparatus according to the first embodiment of the present invention in which some of the sheets during the double-sided printing are discharged to the sheet discharge destinations different from those in FIG. 12;

FIG. 14 is a schematic view of a state of the image forming apparatus according to the first embodiment of the present invention in which some of the sheets during the double-sided printing are discharged to the sheet discharge destinations different from those in FIGS. 12 and 13;

FIG. 15 is a diagram illustrating an example of a sheet discharge destination management table used by the image forming apparatus according to the first embodiment of the present invention;

FIG. 16 is a sequence diagram illustrating an operation based on the software module of the image forming apparatus according to the first embodiment of the present invention;

FIG. 17 is a flowchart illustrating an operation of hardware of the image forming apparatus according to the first embodiment of the present invention;

FIG. 18 is a flowchart illustrating a procedure of misfed sheet detection control processing executed by the image forming apparatus according to the first embodiment of the present invention;

FIG. 19 is a flowchart illustrating a procedure of print head control processing executed by the image forming apparatus according to the first embodiment of the present invention;

FIG. 20 is a flowchart illustrating a procedure of sheet conveyance control processing executed by the image forming apparatus according to the first embodiment of the present invention;

FIG. 21 is a flowchart illustrating a procedure of remaining sheet detection control processing executed by the image forming apparatus according to the first embodiment of the present invention;

FIG. 22 is a flowchart illustrating a procedure of conveyance rerouting control processing executed by the image forming apparatus according to the first embodiment of the present invention; and

FIG. 23 is a flowchart illustrating a procedure of conveyance rerouting control processing executed by an image forming apparatus according to a second embodiment of the present invention.

### DESCRIPTION OF THE EMBODIMENTS

Hereinafter, embodiments will be described in detail with reference to the drawings.

### First Embodiment

### <Configuration of Image Forming Apparatus>

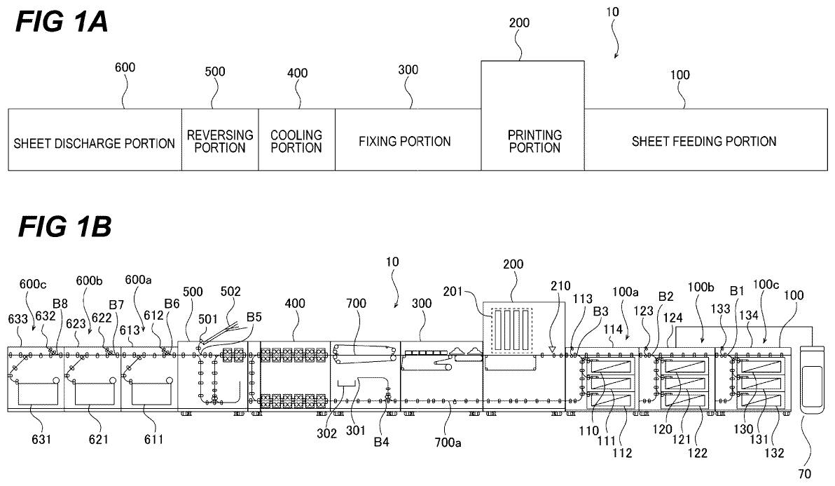

A configuration of an image forming apparatus 10 according to a first embodiment of the present invention will be described in detail with reference to FIGS. 1A to 3.

FIG. 1A illustrates an entire configuration of the image forming apparatus 10, and FIG. 1B illustrates an internal configuration of the image forming apparatus 10.

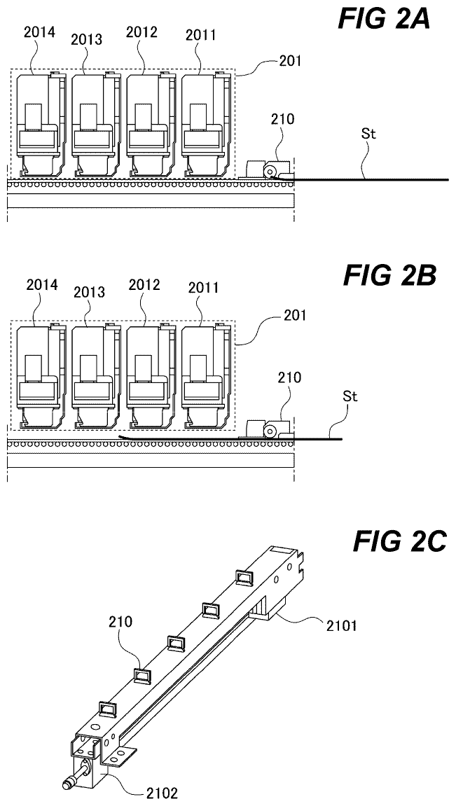

FIG. 2A illustrates a state in which an inkjet head 201 is moved to a printing position, FIG. 2B illustrates a state in which the inkjet head 201 is moved to a retraction position, and FIG. 2C is a perspective view of an optical sensor 210. Here, printing means forming an image.

Here, the image forming apparatus 10 as an inkjet recording apparatus is exemplified by a large commercial printer including a plurality of sheet discharge ports. A print server 70 is connected to the image forming apparatus 10. The image forming apparatus 10 starts a printing operation by receiving a print job transmitted from the print server 70. Here, the print server 70 can confirm a state of the image forming apparatus 10, monitor the print job, and perform maintenance control, and can execute various functions of the image forming apparatus 10 by comprehensively operating the image forming apparatus 10.

Specifically, the image forming apparatus 10 includes a sheet feeding portion 100, a printing portion 200, a fixing portion 300, a cooling portion 400, a reversing portion 500, a sheet discharge portion 600, a conveying portion 700, a controller unit 1000, and a printer engine 1009. The sheet feeding portion 100, the printing portion 200, the fixing portion 300, the cooling portion 400, the reversing portion 500, and the sheet discharge portion 600 are configured as units that can be physically connected to and separated from each other.

The sheet feeding portion 100 is a unit that holds a sheet and feeds the held sheet to the printing portion 200. The sheet feeding portion 100 includes a first stage sheet feeding portion 100a, a second stage sheet feeding portion 100b, and a third stage sheet feeding portion 100c. The sheet feeding portion 100 has a configuration in which three sheet feeding portions of the first stage sheet feeding portion 100a, the second stage sheet feeding portion 100b, and the third stage sheet feeding portion 100c having the same configuration are continuously connected.

The first stage sheet feeding portion 100a accommodates the sheet and feeds the accommodated sheet to the printing portion 200. The first stage sheet feeding portion 100a includes a sheet feeding cassette 110, a sheet feeding cassette 111, a sheet feeding cassette 112, a sheet discharge port 113, a sheet feeding portion 1TOP tray 114, a feeding portion 115, a feeding portion 116, and a feeding portion 117.

The sheet feeding cassette 110 as an accommodating portion is the uppermost sheet feeding cassette, and accommodates various sheets used for printing processing.

The sheet feeding cassette 111 as the accommodating portion is the middle sheet feeding cassette disposed between the sheet feeding cassette 110 and the sheet feeding cassette 112, and accommodates various sheets used for the printing processing.

The sheet feeding cassette 112 as the accommodating portion is the lowermost sheet feeding cassette, and accommodates various sheets used for the printing processing.

The sheet discharge port 113 is provided to discharge and retract the sheet conveyed by the conveying portion 700 to the sheet feeding portion 1TOP tray 114. The sheet discharge port 113 is provided at a distal end of a branch path P1 branched from a branch position B3 of the conveying portion 700.

The sheet feeding portion 1TOP tray 114 as a first stack tray is provided upstream of the optical sensor 210 described below of the printing portion 200 in a conveyance direction of the sheet (hereinafter, simply referred to as “conveyance direction”). The sheet passing through the branch path P1 and discharged through the sheet discharge port 113 is stacked on the sheet feeding portion 1TOP tray 114.

The feeding portion 115 feeds the sheet accommodated in the sheet feeding cassette 110.

The feeding portion 116 feeds the sheet accommodated in the sheet feeding cassette 111.

The feeding portion 117 feeds the sheet accommodated in the sheet feeding cassette 112.

The second stage sheet feeding portion 100b accommodates the sheet and feeds the accommodated sheet to the printing portion 200. The second stage sheet feeding portion 100b includes a sheet feeding cassette 120, a sheet feeding cassette 121, a sheet feeding cassette 122, a sheet discharge port 123, a sheet feeding portion 2TOP tray 124, a feeding portion 125, a feeding portion 126, and a feeding portion 127.

The sheet feeding cassette 120 as the accommodating portion is the uppermost sheet feeding cassette, and accommodates various sheets used for the printing processing.

The sheet feeding cassette 121 as the accommodating portion is the middle sheet feeding cassette disposed between the sheet feeding cassette 120 and the sheet feeding cassette 122, and accommodates various sheets used for the printing processing.

The sheet feeding cassette 122 as the accommodating portion is the lowermost sheet feeding cassette, and accommodates various sheets used for the printing processing.

The sheet discharge port 123 is provided to discharge and retract the sheet conveyed by the conveying portion 700 to the sheet feeding portion 2TOP tray 124. The sheet discharge port 123 is provided at a distal end of a branch path P2 branched from a branch position B2 of the conveying portion 700.

The sheet feeding portion 2TOP tray 124 as the first stack tray is provided upstream of the optical sensor 210 of the printing portion 200 in the conveyance direction. The sheet passing through the branch path P2 and discharged through the sheet discharge port 123 is stacked on the sheet feeding portion 2TOP tray 124.

The feeding portion 125 feeds the sheet accommodated in the sheet feeding cassette 120.

The feeding portion 126 feeds the sheet accommodated in the sheet feeding cassette 121.

The feeding portion 127 feeds the sheet accommodated in the sheet feeding cassette 122.

The third stage sheet feeding portion 100c accommodates the sheet and feeds the accommodated sheet to the printing portion 200. The third stage sheet feeding portion 100c includes a sheet feeding cassette 130, a sheet feeding cassette 131, a sheet feeding cassette 132, a sheet discharge port 133, a sheet feeding portion 3TOP tray 134, a feeding portion 135, a feeding portion 136, and a feeding portion 137.

The sheet feeding cassette 130 as the accommodating portion is the uppermost sheet feeding cassette, and accommodates various sheets used for the printing processing.

The sheet feeding cassette 131 as the accommodating portion is the middle sheet feeding cassette disposed between the sheet feeding cassette 130 and the sheet feeding cassette 132, and accommodates various sheets used for the printing processing.

The sheet feeding cassette 132 as the accommodating portion is the lowermost sheet feeding cassette, and accommodates various sheets used for the printing processing.

The sheet discharge port 133 is provided to discharge and retract the sheet conveyed by the conveying portion 700 to the sheet feeding portion 3TOP tray 134. The sheet discharge port 133 is provided at a distal end of a branch path P3 branched from a branch position B1 of the conveying portion 700.

The sheet feeding portion 3TOP tray 134 as the first stack tray is provided upstream of the optical sensor 210 of the printing portion 200 in the conveyance direction. The sheet passing through the branch path P3 and discharged through the sheet discharge port 133 is stacked on the sheet feeding portion 3TOP tray 134.

The feeding portion 135 feeds the sheet accommodated in the sheet feeding cassette 130.

The feeding portion 136 feeds the sheet accommodated in the sheet feeding cassette 131.

The feeding portion 137 feeds the sheet accommodated in the sheet feeding cassette 132.

The printing portion 200 is a unit that performs an image forming process by performing an image forming operation of printing the image on the sheet conveyed by the conveying portion 700. In single-sided printing in which the image is printed only on the front side, the printing portion 200 prints the image on the front side of the sheet which is fed from the sheet feeding portion 100 and of which the front side and the back side are both blank. In double-sided printing in which the image is printed on both of the front side and the back side, the printing portion 200 prints the image on the front side of the sheet which is fed from the sheet feeding portion 100 and of which both sides are blank. In the double-sided printing, the printing portion 200 prints the image on the back side of the sheet which is conveyed by the conveying portion 700 from the sheet feeding portion 100 and on which the image has been printed only on the front side. The printing portion 200 includes the inkjet head 201 and the optical sensor 210.

The inkjet head 201 as an ink head portion is movable between the printing position illustrated in FIG. 2A and the retraction position illustrated in FIG. 2B under the control of a head controller 1010. Here, the printing position is a position where the image is printed by approaching the sheet conveyed by the conveying portion 700 and ejecting ink. In addition, the retraction position is a position separated from the sheet conveyed by the conveying portion 700 in order to avoid contact with a misfed sheet as an abnormal sheet where an abnormality such as a corner fold at an edge portion or uplift has occurred (hereinafter, simply referred to as “misfed sheet”).

The inkjet head 201 includes a plurality of recording heads 2011, 2012, 2013, and 2014.

The recording head 2011, the recording head 2012, the recording head 2013, and the recording head 2014 are line type recording heads using an inkjet method and arranged in the conveyance direction of the sheet (hereinafter, simply referred to as “conveyance direction”). A method using a heat generating element, a method using a piezoelectric element, a method using an electrostatic element, a method using a MEMS element, or the like can be adopted as the inkjet method. Ink of each color is supplied from an ink reservoir to each of the recording head 2011, the recording head 2012, the recording head 2013, and the recording head 2014 via an ink tube.

The recording head 2011, the recording head 2012, the recording head 2013, and the recording head 2014 are recording heads of four colors of Bk (black), Y (yellow), M (magenta), and C (cyan), respectively. The number of colors and the number of recording heads of the inkjet head 201 are not limited to four colors and four and may be any number of colors and any number. For example, the number of colors may be one, and the number of recording heads may be one.

The optical sensor 210 as a detector detects the abnormality such as a fold, uplift, or a length in a width direction orthogonal to the conveyance direction of the sheet conveyed to the inkjet head 201 by the conveying portion 700, and outputs an electric signal corresponding to a detection result to the controller unit 1000. Here, the abnormality in the length of the sheet in the width direction means a case where a size of the sheet to be conveyed is different from a size of the sheet selected by a user. The optical sensor 210 is provided downstream of the first stage sheet feeding portion 100a, the second stage sheet feeding portion 100b, and the third stage sheet feeding portion 100c in the conveyance direction, is provided upstream of the inkjet head 201, and detects the misfed sheet before the image is printed by the inkjet head 201.

Specifically, the optical sensor 210 includes a light projecting portion 2101 and a light receiving portion 2102.

The light projecting portion 2101 emits a laser toward the light receiving portion 2102.

The light receiving portion 2102 includes a light receiving element (CCD). The light receiving portion 2102 enters a light receiving state in which the laser emitted from the light projecting portion 2101 is received by the light receiving element or a light blocked state in which the laser cannot be received by the light receiving element because the laser is blocked by a blocking object interposed between the light receiving element and the light projecting portion 2101. The blocking object is the corner fold of the misfed sheet, the uplift of the misfed sheet, or the like.

In a case where the light receiving element of the light receiving portion 2102 is in the light blocked state because there is a blocking object between the light projecting portion 2101 and the light receiving portion 2102, a bright portion (light incident portion) that receives the laser from the light projecting portion 2101 and a dark portion (light blocked portion) that corresponds to a shadow of the blocking object are generated. The light receiving portion 2102 outputs an electric signal corresponding to a light receiving quantity of the laser in the light receiving state or the light blocked state of the light receiving element to the controller unit 1000 via the printer engine 1009.

The fixing portion 300 is a unit that performs fixing control by performing a fixing process of fixing the image on the sheet which is conveyed by the conveying portion 700 and on which the image has been printed in the printing portion 200 by using a plurality of heater units. The fixing portion 300 includes a sheet discharge port 301.

The sheet discharge port 301 is provided to discharge and retract the sheet conveyed by the conveying portion 700 to a fixing portion double-sided tray 302. The sheet discharge port 301 is provided at a distal end of a branch path branched from a branch position B4 of the conveying portion 700.

The cooling portion 400 is a unit that performs a cooling process by performing temperature control of cooling the sheet which is conveyed by the conveying portion 700 and on which the image is fixed in the fixing portion 300 to normal temperature by using a plurality of fan units.

The reversing portion 500 is a unit that performs switchback conveyance of the sheet cooled in the cooling portion 400 and conveyed by the conveying portion 700. The reversing portion 500 performs a reversing process of reversing the front side and the back side of the sheet such that the back side of the sheet printed on both of the front side and the back side is changed from an upper side to a lower side by performing switchback conveyance of the sheet. The reversing portion 500 includes a sheet discharge port 501 and a reversing portion TOP tray 502.

The sheet discharge port 501 is provided to discharge and retract the sheet conveyed by the conveying portion 700 to the reversing portion TOP tray 502 as a sheet discharge destination. The sheet discharge port 501 is provided at a distal end of a branch path branched from a branch position B5 of the conveying portion 700.

The sheet discharged from the sheet discharge port 501 is stacked on the reversing portion TOP tray 502 as a second stack tray.

The sheet discharge portion 600 is a unit that performs control to stack and discharge the sheet conveyed by the conveying portion 700 from the reversing portion 500. The sheet discharge portion 600 has a configuration in which three units of the same sheet discharge portions of a first stage sheet discharge portion 600a, a second stage sheet discharge portion 600b, and a third stage sheet discharge portion 600c are continuously connected.

The first stage sheet discharge portion 600a includes a discharged sheet stacker 611, a sheet discharge port 612, and a sheet discharge portion 1TOP tray 613.

The sheet which is discharged by the conveying portion 700 and on which the image has been printed is stacked on the discharged sheet stacker 611 as a third stack tray.

The sheet discharge port 612 is provided to discharge and retract the sheet conveyed by the conveying portion 700 to the sheet discharge portion 1TOP tray 613. The sheet discharge port 612 is provided at a distal end of a branch path branched from a branch position B6 of the conveying portion 700.

The sheet discharged through the sheet discharge port 612 is stacked on the sheet discharge portion 1TOP tray 613.

The second stage sheet discharge portion 600b includes a discharged sheet stacker 621, a sheet discharge port 622, and a sheet discharge portion 2TOP tray 623.

The sheet which is discharged by the conveying portion 700 on which the image has been printed is stacked on the discharged sheet stacker 621 as the third stack tray.

The sheet discharge port 622 is provided to discharge and retract the sheet conveyed by the conveying portion 700 to the sheet discharge portion 2TOP tray 623. The sheet discharge port 622 is provided at a distal end of a branch path branched from a branch position B7 of the conveying portion 700.

The sheet discharged through the sheet discharge port 622 is stacked on the sheet discharge portion 2TOP tray 623.

The third stage sheet discharge portion 600c includes a discharged sheet stacker 631, a sheet discharge port 632, and a sheet discharge portion 3TOP tray 633.

The sheet which is discharged by the conveying portion and on which the image has been printed is stacked on the discharged sheet stacker 631 as the third stack tray.

The sheet discharge port 632 is provided to discharge and retract the sheet conveyed by the conveying portion 700 to the sheet discharge portion 3TOP tray 633. The sheet discharge port 632 is provided at a distal end of a branch path branched from a branch position B8 of the conveying portion 700.

The sheet discharged through the sheet discharge port 632 is stacked on the sheet discharge portion 3TOP tray 633.

The conveying portion 700 includes a double-sided conveyance path 700a that conveys the sheet from the cooling portion 400 to the fixing portion 300 and the printing portion 200. During the single-sided printing, the conveying portion 700 conveys the sheet fed from the sheet feeding portion 100 in the order of the printing portion 200, the fixing portion 300, the cooling portion 400, the reversing portion 500, and the sheet discharge portion 600. During the double-sided printing, the conveying portion 700 conveys the sheet fed from the sheet feeding portion 100 in the order of the printing portion 200, the fixing portion 300, and the cooling portion 400. Thereafter, the conveying portion 700 conveys the sheet in the order of the cooling portion 400, the fixing portion 300, the printing portion 200, the sheet feeding portion 100, the printing portion 200, the fixing portion 300, the cooling portion 400, the reversing portion 500, and the sheet discharge portion 600.

The conveying portion 700 performs sheet discharge to the sheet feeding portion 1TOP tray 114, the sheet feeding portion 2TOP tray 124, the sheet feeding portion 3TOP tray 134, or the fixing portion double-sided tray 302 through the sheet discharge port 113, 123, 133, or 301. Alternatively, the conveying portion 700 performs sheet discharge to the reversing portion TOP tray 502, the sheet discharge portion 1TOP tray 613, the sheet discharge portion 2TOP tray 623, or the sheet discharge portion 3TOP tray 633 through the sheet discharge port 501, 612, 622, or 623.

The controller unit 1000 is connected to an external device via the printer engine 1009 and a local area network 1007. The controller unit 1000 comprehensively controls an operation of the image forming apparatus 10, and performs input/output control of device information and a sensor signal with the printer engine 1009 and an external device.

The controller unit 1000 is not limited to be configured as one unit, and may be provided in each of the sheet feeding portion 100, the printing portion 200, the fixing portion 300, the cooling portion 400, the reversing portion 500, and the sheet discharge portion 600. In a case where the controller unit 1000 is provided in each of the sheet feeding portion 100, the printing portion 200, the fixing portion 300, the cooling portion 400, the reversing portion 500, and the sheet discharge portion 600, a specific controller unit 1000 comprehensively controls the other controller units 1000.

The controller unit 1000 includes a central processing unit (CPU) 1001, a random access memory (RAM) 1002, a read only memory (ROM) 1003, a hard disk drive (HDD) 1004, a network interface (I/F) 1006, a device I/F 1008, a head controller 1010, and a conveyance controller 1011.

The CPU 1001 as a controller reads a program stored in the ROM 1003 or the HDD 1004, stores the program in the RAM 1002, and executes the program stored in the RAM 1002 to control the operation of the image forming apparatus 10.

The CPU 1001 executes the program stored in the RAM 1002 to comprehensively control each device connected via a system bus 1005. When the image forming apparatus 10 is powered on, the CPU 1001 performs predetermined control by reading and executing the program stored in the ROM 1003. The CPU 1001 installs the program received by the network I/F 1006 in the ROM 1003 or the HDD 1004. The CPU 1001 transmits data or device information generated in the control of the operation of the image forming apparatus 10 to an external device via the network I/F 1006 and the local area network 1007.

The CPU 1001 acquires image data transferred from the print server 70 via the local area network 1007 and the network I/F 1006. The CPU 1001 drives each device of the printer engine 1009 via the device I/F 1008 based on the acquired image data to print the image on the sheet.

The CPU 1001 controls the head controller 1010 and the conveyance controller 1011 based on an electric signal input from the optical sensor 210 via the printer engine 1009 and the device I/F 1008.

Specifically, the CPU 1001 executes misfed sheet detection control processing described below to detect the misfed sheet based on an electric signal corresponding to the light receiving state or the light blocked state in the light receiving element of the light receiving portion 2102 input from the optical sensor 210. For example, the CPU 1001 determines a portion where the light receiving quantity of the light receiving portion 2102 indicated by the electric signal input from the light receiving portion 2102 is less than a reference as the light blocked portion, and detects the misfed sheet that is the blocking object in a case where the light blocked portion occupies a predetermined ratio or more.

When the misfed sheet is detected, the CPU 1001 executes print head control processing described below to control the head controller 1010 to move and retract the inkjet head 201 from the printing position to the retraction position. When the misfed sheet is detected, the CPU 1001 executes sheet conveyance control processing described below to control the conveyance controller 1011 to discharge the sheet (hereinafter, referred to as “preceding sheet”) conveyed before the abnormal sheet to a normal sheet discharge destination and discharge and temporarily retract the sheet (hereinafter, referred to as “subsequent sheet”) conveyed after the abnormal sheet to a predetermined sheet discharge destination.

When the misfed sheet is detected, the CPU 1001 executes remaining sheet detection processing described below to discharge the misfed sheet and the subsequent sheet, and then check whether or not there is a sheet remaining on a conveyance path.

The CPU 1001 is not limited to be provided in the controller unit 1000, and may be provided in a controller unit present in each of the sheet feeding portion 100, the printing portion 200, the fixing portion 300, the cooling portion 400, the reversing portion 500, and the sheet discharge portion 600.

The RAM 1002 functions as a main memory or a work memory of the CPU 1001. The RAM 1002 stores the program read from the ROM 1003 or the HDD 1004 by the CPU 1001.

The ROM 1003 stores various programs such as a control program and a boot program, and various tables including a sheet discharge destination management table described below.

The HDD 1004 stores various programs including an operating system (OS) program. The HDD 1004 is also used for the purpose of temporarily or long-term holding a large amount of data. The program stored in the HDD 1004 is described below.

The network I/F 1006 is an interface unit with the local area network 1007, and is connected to the local area network 1007. The network I/F 1006 receives data, device information, or a program from an external device via the local area network 1007, and outputs the received data, device information, or program to the CPU 1001. The network I/F 1006 transmits data or device information output from the CPU 1001 to an external device via the local area network 1007.

The device I/F 1008 is an interface unit with the printer engine 1009, and is connected to the printer engine 1009. The device I/F 1008 inputs and outputs signals for operating and referring to various motors, sensors, the inkjet head 201, and the like between the CPU 1001 and the printer engine 1009.

The head controller 1010 controls an operation of the inkjet head 201 included in the printer engine 1009 via the device I/F 1008 under the control of the CPU 1001. The conveyance controller 1011 controls an operation of feeding the sheet

from the sheet feeding portion 100 under the control of the CPU 1001. The conveyance controller 1011 controls an operation of a conveyance motor under the control of the CPU 1001 in order to convey the sheet by the conveying portion 700 and discharge the sheet to the sheet discharge portion 600 in synchronization with an ink discharge timing of the inkjet head 201. The conveyance controller 1011 controls sensors including the optical sensor 210 under the control of the CPU 1001. The conveyance controller 1011 controls the operation of the conveyance motor under the control of the CPU 1001 to discharge and temporarily retract the subsequent sheet to the predetermined sheet discharge destination when the misfed sheet is detected.

The printer engine 1009 includes the inkjet head 201 and the like. The optical sensor 210, various motors, and the like are connected to the printer engine 1009. The printer engine 1009 is an inkjet type output device that conveys the sheet under the control of the controller unit 1000 and prints the image on the sheet by the inkjet head 201.

### <Configuration of Software Module Included in Image Forming Apparatus>

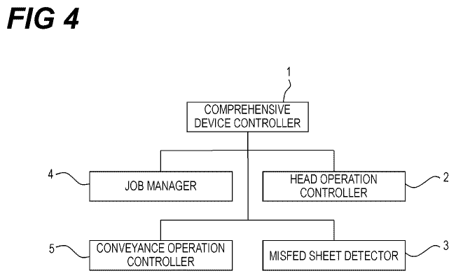

A configuration of a software module included in the image forming apparatus 10 according to the first embodiment of the present invention will be described in detail with reference to FIG. 4.

The image forming apparatus 10 includes the software module including a comprehensive device controller 1, a head operation controller 2, a misfed sheet detector 3, a job manager 4, and a conveyance operation controller 5. The software module is stored in the HDD 1004 as a program.

The comprehensive device controller 1 comprehensively controls execution of the sheet conveyance control processing, control processing for the sensors such as the optical sensor 210, the print head control processing, job control processing, and the like.

The head operation controller 2 controls an operation related to the inkjet head 201. The operation related to the inkjet head 201 includes an operation of ejecting the ink onto the sheet, an operation of moving the inkjet head 201 to the retraction position when the misfed sheet is detected, an operation of moving the inkjet head 201 to the printing position after error recovery processing, and the like. Here, the error recovery processing is processing of retracting the print job being executed when the misfed sheet is detected and discharging the misfed sheet and the subsequent sheet to the predetermined sheet discharge destination to prepare for the retracted print job to be re-input.

The misfed sheet detector 3 controls the optical sensor 210 to monitor a state of the sheet conveyed during the print job, and immediately notifies the comprehensive device controller 1 of detection of the misfed sheet.

The job manager 4 performs scheduling for the print job, temporary retraction control for print job data at the time of the error recovery processing, regeneration control for the print job data for arranging the page order of the sheets, and scheduling after the error recovery processing.

The conveyance operation controller 5 controls conveyance of the sheet for the print job, discharge of the misfed sheet to the sheet discharge destination, retraction of the subsequent sheet to the sheet discharge destination when the misfed sheet is detected, and re-conveyance of the sheet for a recovery job.

### <Conveyance Operation of Image Forming Apparatus During Single-Sided Job>

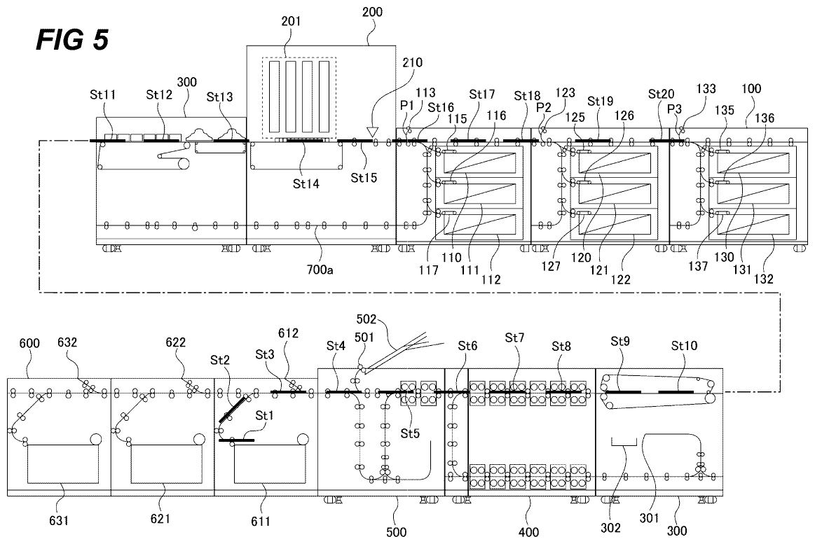

A conveyance operation of the image forming apparatus 10 during a single-sided job according to the first embodiment of the present invention will be described in detail with reference to FIGS. 5 to 9. Here, the single-sided job is a print job of printing the image only on the front side of the sheet.

FIGS. 5 to 9 illustrate, as an example, a state in which 20 sheets from St1 to St20 are conveyed into the image forming apparatus 10.

Here, in FIG. 5, St1 has reached the discharged sheet stacker 611, and St16 is the misfed sheet and is at a position immediately before being detected as the misfed sheet by the optical sensor 210. Further, St1 to St15 which are the preceding sheets and St17 to St20 which are the subsequent sheets are the normal sheets where the corner fold at an edge portion or the uplift has not occurred.

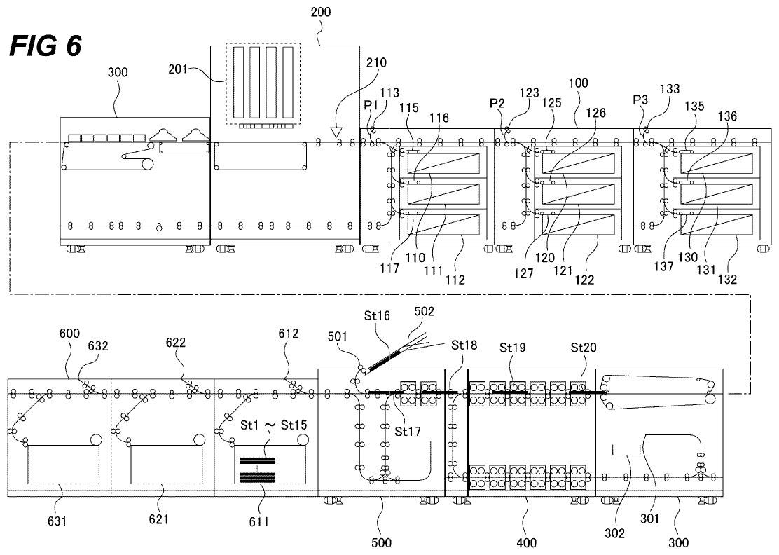

St16 is discharged through the sheet discharge port 501 of the reversing portion 500 after being detected as the misfed sheet by the optical sensor 210 as illustrated in FIG. 6. In addition, St1 to St15, which are the normal sheets on which the image has been printed on both of the front side and the back side, are discharged to the discharged sheet stacker 611 which is the normal sheet discharge destination.

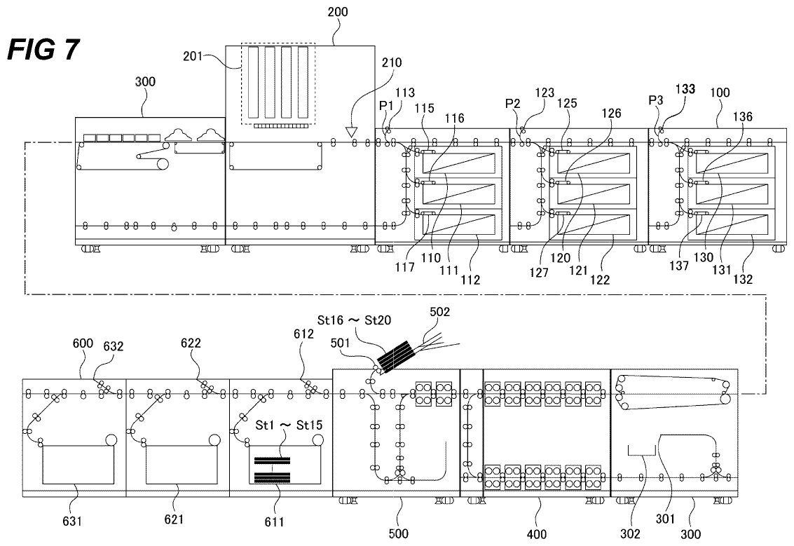

In this state, in FIG. 7 in which St17 to St20 are discharged through the sheet discharge port 501, St16 which is the misfed sheet and St17 to St20 which are the normal sheets are discharged to the same sheet discharge destination.

In FIG. 7, a downtime until retraction of St16 to St20 through the sheet discharge port 501 is completed increases. In addition, St16 which is the abnormal sheet and St17 to St20 which are the normal sheets are discharged through the sheet discharge port 501 in a mixed manner. As a result, in the error recovery processing, it is necessary to confirm a state of the sheet discharged through the sheet discharge port 501 and manually separate only St17 to St20, which are the normal sheets, and thus convenience is deteriorated.

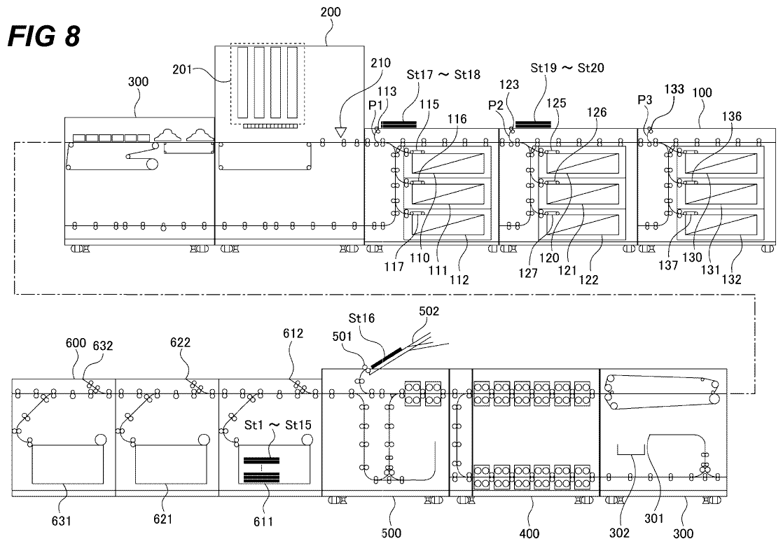

Therefore, as illustrated in FIG. 8, St16, which is the misfed sheet, is discharged through the sheet discharge port 501, St17 and St18, which are the normal sheets, are discharged through the sheet discharge port 113 of the first stage sheet feeding portion, and St19 and St20, which are the normal sheets, are discharged through the sheet discharge port 123 of the second stage sheet feeding portion.

In FIG. 8, St17 and St18, which are the normal sheets, are discharged through the closest downstream sheet discharge port 113 in the conveyance direction, and St19 and St20, which are the normal sheets, are discharged through the closest downstream sheet discharge port 123 in the conveyance direction. As a result, it is possible to discharge and retract St17 to St20, which are the normal sheets, to the sheet discharge destination with the shortest downtime. In addition, since St16 which is the misfed sheet and St17 to St20 which are the normal sheets can be discharged to different sheet discharge destinations and separated, convenience can be improved.

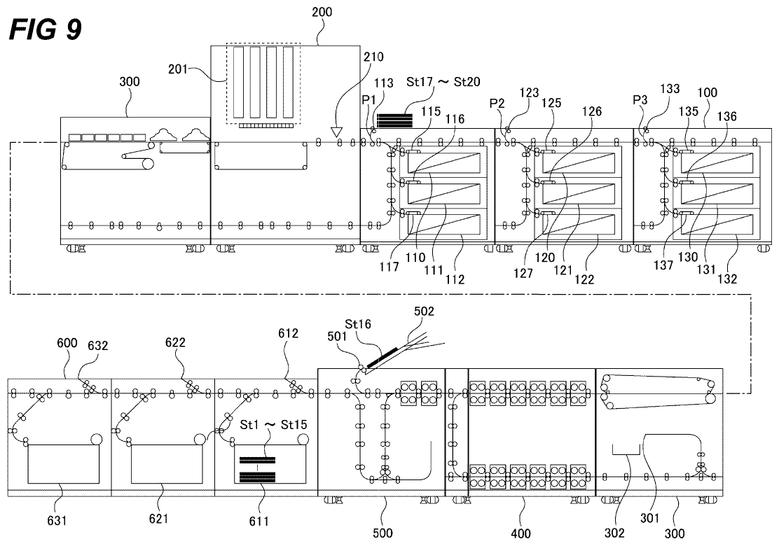

Further, as illustrated in FIG. 9, St16, which is the misfed sheet, is discharged through the sheet discharge port 501, and St17 to St20, which are the normal sheets, are discharged through the sheet discharge port 113.

In FIG. 9, by discharging St17 to St20, which are the normal sheets, through the sheet discharge port 113 that is upstream of the sheet discharge port 501 in the conveyance direction, the downtime can be shortened as compared with the case of FIG. 7. In addition, since St17 to St20, which are the normal sheets, can be collectively discharged through the sheet discharge port 113, convenience can be further improved.

### <Conveyance Operation of Image Forming Apparatus During Double-Sided Job>

A conveyance operation of the image forming apparatus 10 during a double-sided job according to the first embodiment of the present invention will be described in detail with reference to FIG. 4. Here, the double-sided job is a print job of printing the image on both sides of the sheet.

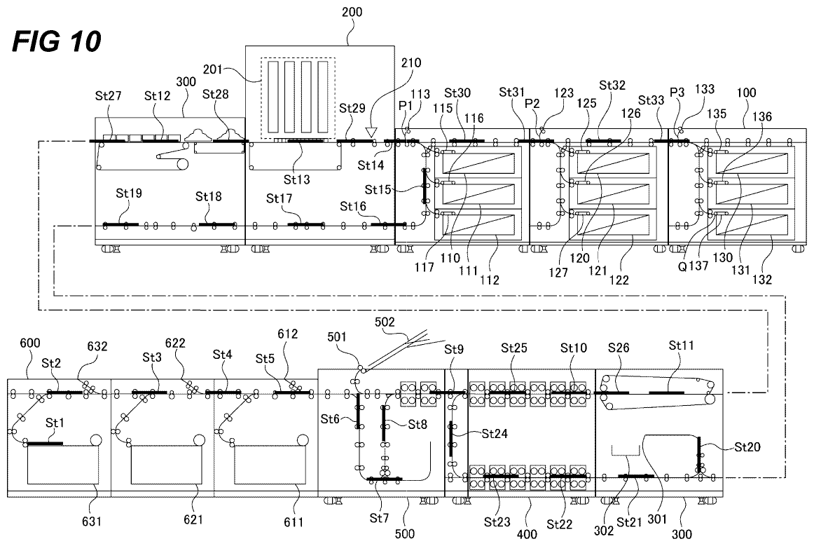

FIGS. 10 to 14 illustrate, as an example, a state in which 33 sheets from St1 to St33 are conveyed into the image forming apparatus 10.

Here, in FIG. 10, St1 has reached the discharged sheet stacker 611, and St14 is the misfed sheet and is at a position immediately before being detected as the misfed sheet by the optical sensor 210. St1 to St13, which are the preceding sheets, and St15 to St33, which are the subsequent sheets, are the normal sheets. Further, St15 to St24 are the sheets retained on the double-sided conveyance path 700a.

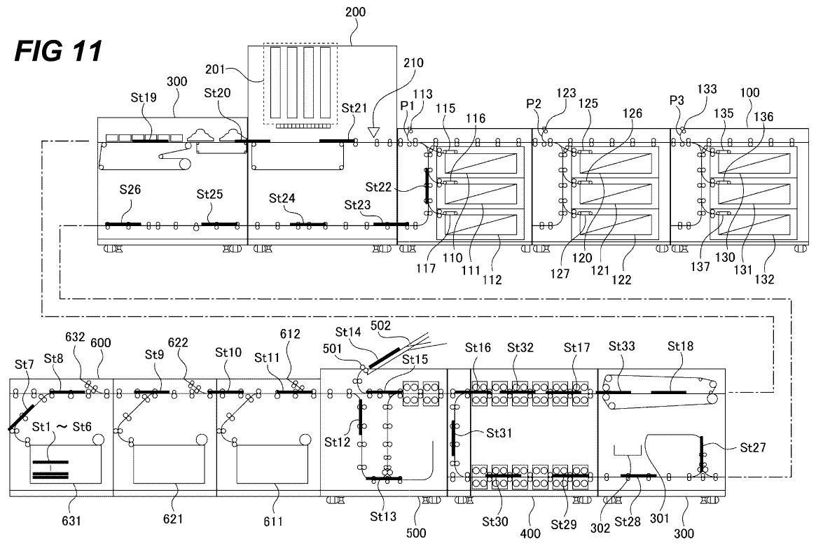

St14 is discharged through the sheet discharge port 501 of the reversing portion 500 after being detected as the misfed sheet by the optical sensor 210 as illustrated in FIG. 11.

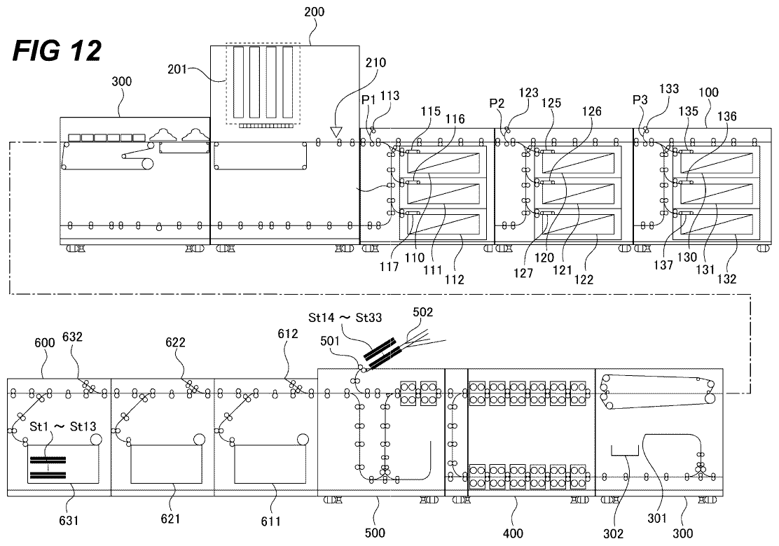

In this state, in FIG. 12 in which St15 to St33 are discharged through the sheet discharge port 501, St14 which is the misfed sheet and St15 to St33 which are the normal sheets are discharged to the same sheet discharge destination. In addition, St1 to St13, which are the normal sheets on which the image has been printed on both of the front side and the back side, are discharged to the discharged sheet stacker 631 which is the normal sheet discharge destination.

In FIG. 12, a downtime until retraction of St14 to St33 through the sheet discharge port 501 is completed increases. In addition, St14 which is the abnormal sheet and St15 to St33 which are the normal sheets are discharged through the sheet discharge port 501 in a mixed manner. As a result, in the error recovery processing, it is necessary to confirm a state of the sheet discharged through the sheet discharge port 501 and manually separate only St15 to St33, which are the normal sheets, and thus convenience is deteriorated.

Further, in the case of the double-sided job, it is necessary to pay attention to the fact that St25 to St29 on which the image has been printed only on the front side and of which page numbers are subsequent to that of St14 are present downstream of St14, which is the misfed sheet, in the conveyance direction.

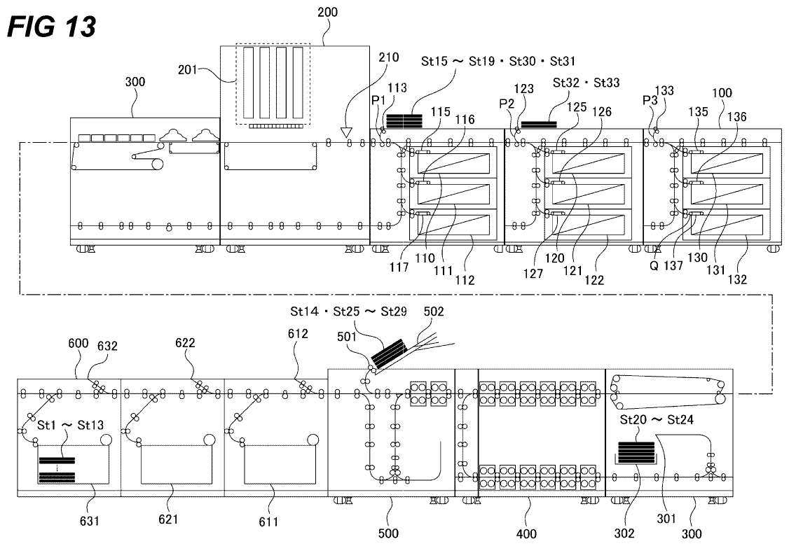

Therefore, as illustrated in FIG. 13, St14, which is the misfed sheet, is discharged through the sheet discharge port 501, St15 and St19, which are the normal sheets, are discharged through the sheet discharge port 113 of the first stage sheet feeding portion, and St20 and St24, which are the normal sheets, are discharged through the sheet discharge port 301 of the second stage sheet feeding portion. In addition, St25 to St29, which are the normal sheets, are discharged and retracted through the sheet discharge port 501 of the reversing portion 500. Further, St30 and St31, which are the normal sheets, are discharged through the sheet discharge port 113 of the first stage sheet feeding portion, and St32 and St33, which are the normal sheets, are discharged and retracted through the sheet discharge port 123 of the second stage sheet feeding portion.

In FIG. 13, St15 to St19, which are the normal sheets, are discharged through the closest downstream sheet discharge port 113 in the conveyance direction, and St20 and St24, which are the normal sheets, are discharged through the closest downstream sheet discharge port 301 in the conveyance direction. In addition, St25 to St29, which are the normal sheets, are discharged through the closest downstream sheet discharge port 501 in the conveyance direction. Further, St30 and St31, which are the normal sheets, are discharged through the closest downstream sheet discharge port 113 in the conveyance direction, and St32 and St33, which are the normal sheets, are discharged through the closest downstream sheet discharge port 123 in the conveyance direction. As a result, it is possible to discharge and retract St15 to St33, which are the normal. sheets, to the sheet discharge destination with the shortest downtime.

On the other hand, in FIG. 13, St14, which is the misfed sheet, and St25 to St29, which are the normal sheets on which the image has been printed only on the front side, are discharged through the sheet discharge port 501 in a mixed manner. In addition, St30 and St31, which are the blank normal sheets, and St15 to St19, which are the normal sheets on which the image has been printed only on the front side, are discharged through the sheet discharge port 113 in a mixed manner. Further, St32 and St33, which are the blank normal sheets, are discharged through the sheet discharge port 123, and St30 and St31, which are the blank normal sheets, are discharged through the sheet discharge port 113 in a dispersed manner, which leads to a lack of organization.

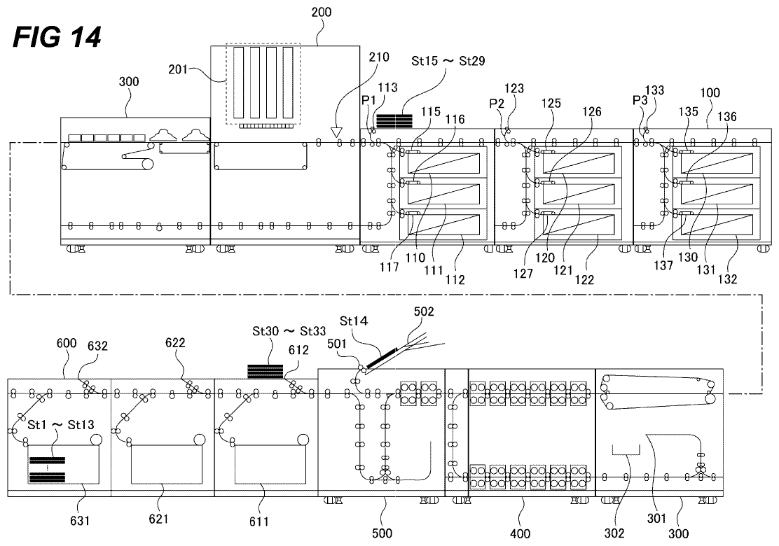

Therefore, as illustrated in FIG. 14, St14, which is the misfed sheet, is discharged through the sheet discharge port 501, and St30 to St33, which are the blank normal sheets, are discharged through the sheet discharge port 612 that is downstream of the printing portion 200 in the conveyance direction. In addition, St15 to St29, which are the normal sheets on which the image has been printed only on the front side, are discharged through the sheet discharge port 113 that is upstream of the printing portion 200 in the conveyance direction.

In FIG. 14, since it is possible to separately discharge St14, which is the misfed sheet, and St15 to St33, which are the normal sheets, it is possible to improve convenience. In addition, it is possible to separately St30 to St33, which are the blank normal sheets, and St15 to St29, which are the normal sheets on which the image has been printed only on the front side. As a result, St15 to St33, which are the normal sheets, can be discharged in units of organized bundles in consideration of a double-sided printing state, a single-sided printing state in which the image has been printed only on the front side, the printing state in which both sides are blank, and the page order.

### <Operation Based on Software Module of Image Forming Apparatus>

An operation based on the software module of the image forming apparatus 10 according to the first embodiment of the present invention will be described in detail.

The CPU 1001 monitors whether or not there is a misfed sheet among the sheets being conveyed by using the misfed sheet detector 3 while the comprehensive device controller 1 comprehensively controls each processing.

When the misfed sheet is detected by the misfed sheet detector 3, the CPU 1001 causes the misfed sheet detector 3 to immediately notify the head operation controller 2 of the detection, and causes the head operation controller 2 to retract the inkjet head 201 to the retraction position. When the misfed sheet is detected by the misfed sheet detector 3, the CPU 1001 causes the misfed sheet detector 3 to also notify the job manager 4 of the detection, and causes the job manager 4 to temporarily retract the print job data to prepare for the print job after the error recovery processing to be re-input. Further, the CPU 1001 causes the conveyance operation controller 5 to discharge the misfed sheet to the sheet discharge destination and discharge and retract the subsequent sheet that is the normal sheet to the sheet discharge destination corresponding to the printing state.

After the sheet retraction control is completed, the CPU 1001 causes the conveyance operation controller 5 to confirm whether or not there is a remaining sheet on the conveyance path. Then, the CPU 1001 causes the comprehensive device controller 1 to notify the job manager 4 of completion of the error recovery processing and instructs the job manager 4 to re-input the print job, thereby printing the image on the sheet again and ending the operation.

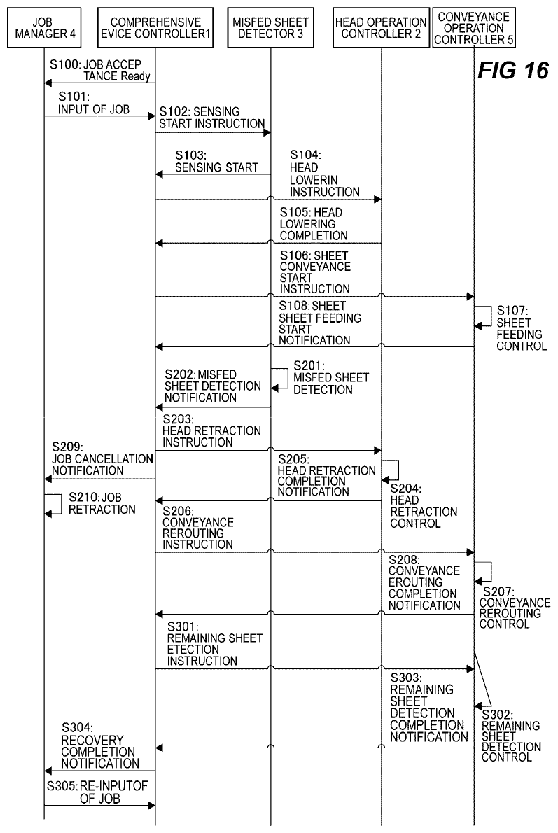

Next, the operation based on the software module of the image forming apparatus 10 will be described in more detail with reference to FIGS. 4 and 16.

The operation of the image forming apparatus 10 illustrated in FIG. 16 is started when the CPU 1001 reads and executes a program of the software module illustrated in FIG. 4, the program being stored in the HDD 1004.

First, the comprehensive device controller 1 notifies the job manager 4 that the print job can be accepted (transmits a message signal indicating “job acceptance Ready”) (S100).

Next, the job manager 4 inputs the print job to the comprehensive device controller 1 (S101).

Next, the comprehensive device controller 1 instructs the misfed sheet detector 3 to start sensing processing by the optical sensor 210 for detecting the misfed sheet (transmits a message signal of “sensing start instruction”) (S102).

Next, the misfed sheet detector 3 notifies the comprehensive device controller 1 that the sensing processing has been started (transmits a message signal of “sensing start”) (S103).

Next, the comprehensive device controller 1 instructs the head operation controller 2 to lower the inkjet head 201 to the printing position in order to print the image on the sheet (transmits a message signal of “head lowering instruction”) (S104).

Next, after lowering the inkjet head 201 to the printing position, the head operation controller 2 notifies the comprehensive device controller 1 of completion of the lowering (transmits a message signal of “head lowering completion”) (S105).

Next, the comprehensive device controller 1 instructs the conveyance operation controller 5 to start conveyance of the sheet (transmits a message signal of “sheet conveyance start instruction”) (S106).

Next, the conveyance operation controller 5 starts sheet feeding control to start sheet feeding from the first stage sheet feeding portion 100a, the second stage sheet feeding portion 100b, or the third stage sheet feeding portion 100c of the sheet feeding portion 100 (S107).

Next, the conveyance operation controller 5 notifies the comprehensive device controller 1 that sheet feeding has been started (transmits a message signal of “sheet feeding start notification”) (S108). As a result, the printing operation is started.

After starting the printing operation, the misfed sheet detector 3 detects the misfed sheet (S201).

Next, the misfed sheet detector 3 notifies the comprehensive device controller 1 that the misfed sheet has been detected (transmits a message signal of “misfed sheet detection notification”) (S202). As a result, the comprehensive device controller 1 starts the error recovery processing.

Next, the comprehensive device controller 1 instructs the head operation controller 2 to retract the inkjet head 201 from the printing position to the retraction position (transmits a message signal of “head retraction instruction”) (S203).

Next, the head operation controller 2 performs head retraction control of retracting the inkjet head 201 from the printing position to the retraction position (S204).

Next, the head operation controller 2 notifies the comprehensive device controller 1 of completion of the retraction control for the inkjet head 201 (transmits a message signal of “head retraction completion notification”) (S205).

In addition, in the error recovery processing, the comprehensive device controller 1 instructs the conveyance operation controller 5 to reroute the subsequent sheet from the current conveyance path to the conveyance path to a temporary retraction destination (transmits a message signal of “conveyance rerouting instruction”) (S206).

Next, the conveyance operation controller 5 executes conveyance rerouting control processing of rerouting to discharge and temporarily retract the subsequent sheet (S207).

Next, the conveyance operation controller 5 notifies the comprehensive device controller 1 of completion of the conveyance rerouting control processing after completing the discharge of all the subsequent sheets to the retraction destination (transmits a message signal of “conveyance rerouting completion notification”) (S208).

Furthermore, in the error recovery processing, the comprehensive device controller 1 notifies the job manager 4 of job cancellation in order to retract the print job data (transmits a message signal of “job cancellation notification”) (S209).

Next, the job manager 4 retracts and holds the print job data being printed (S210).

In the above operation, the operation of step S203, the operation of step S206, and the operation of step S209 by the comprehensive device controller 1 are performed in parallel.

Next, the comprehensive device controller 1 instructs the conveyance operation controller 5 to execute remaining sheet detection control processing for confirming whether or not there is a remaining sheet on the conveyance path (transmits a message signal of “remaining sheet detection instruction”) (S301).

Next, the conveyance operation controller 5 executes the remaining sheet detection control processing of confirming whether or not there is a remaining sheet on the conveyance path (S302).

Next, after the remaining sheet detection control processing is completed, the conveyance operation controller 5 notifies the comprehensive device controller 1 of completion of the remaining sheet detection control processing (transmits a message signal of “remaining sheet detection completion notification”) (S303).

Next, the comprehensive device controller 1 notifies the job manager 4 that the error recovery processing has been completed (transmits a message signal of “recovery completion notification”) (S304).

Next, the job manager 4 re-inputs the print job data being printed to the comprehensive device controller 1, and resumes the print job, the print job data being retracted and held in the processing of step S210 (S305).

### <Operation of Hardware of Image Forming Apparatus>

An operation of hardware of the image forming apparatus 10 according to the first embodiment of the present invention will be described in detail.

The CPU 1001 starts the printing operation when the print job is received, and starts execution of the misfed sheet detection control processing for detecting the misfed sheet, the print head control processing for printing the image on the sheet, and the sheet conveyance control processing for conveying the sheet.

In a case where the misfed sheet has been detected during the printing operation, the CPU 1001 starts the error recovery processing, retracts the inkjet head 201 and the sheet being conveyed, and executes the conveyance rerouting control processing and the remaining sheet detection control processing. Thereafter, the CPU 1001 ends the printing operation in a case where the sheet discharge has been completed up to the last page, with no misfed sheet detected, after the re-input print job is received again and the error recovery processing ends. In addition, the CPU 1001 ends the misfed sheet detection control processing, the print head control processing, and the sheet conveyance control processing.

The sheet during the double-sided job is inspected by the optical sensor 210 as to whether or not the sheet is the misfed sheet, and then passes through the inkjet head 201, so that the image is printed on the front side. Further, the sheet on which the image has been printed on the front side is circulated on the conveyance path, conveyed again to the printing portion 200, inspected by the optical sensor 210 as to whether or not the sheet is the misfed sheet for the second time, and then passes through the inkjet head 201, so that the image is printed on the back side.

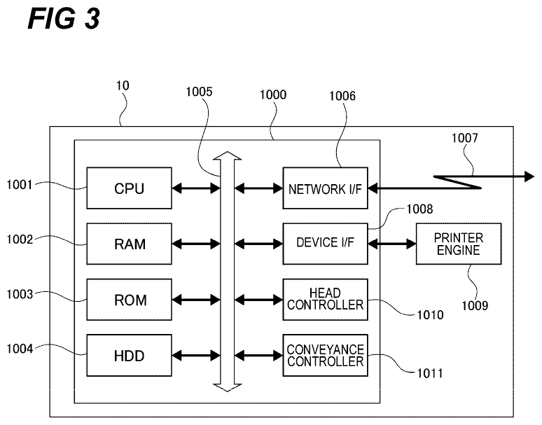

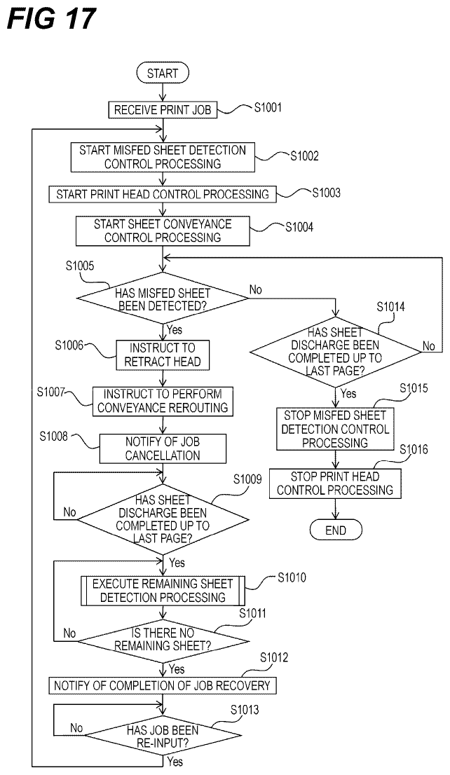

Next, the operation of hardware of the image forming apparatus 10 will be described in more detail with reference to FIGS. 3 and 17.

The operation illustrated in FIG. 17 is started at a timing when the CPU 1001 detects that the print job has been transmitted to the image forming apparatus 10.

First, the CPU 1001 receives the print job from the print server 70 via the local area network 1007 and the network I/F 1006, and stores and holds the print job data in the RAM 1002 (S1001).

Next, the CPU 1001 starts the misfed sheet detection control processing in order to monitor whether or not there is a misfed sheet among the sheets being conveyed according to the operation of step S102 of the operation illustrated in FIG. 16 (S1002). The misfed sheet detection control processing is described below.

Next, the CPU 1001 starts the print head control processing in order to eject the ink onto the sheet and perform printing (S1003). The print head control processing is described below.

Next, the CPU 1001 starts the sheet conveyance control processing in order to convey the sheet (S1004). The sheet conveyance control processing is described below.

Next, the CPU 1001 determines whether or not the misfed sheet has been detected based on the electric signal input from the optical sensor 210 in the misfed sheet detection control processing (S1005).

In a case where the misfed sheet has been detected (step S1005: Yes), the CPU 1001 instructs the inkjet head 201 to move to the retraction position according to the operation of step S203 of the operation illustrated in FIG. 16 (S1006).

Next, the CPU 1001 starts the error recovery processing, and instructs to reroute the subsequent sheet to the conveyance path for retracting the subsequent sheet to the sheet discharge destination as the retraction destination according to the operation of step S206 of the operation illustrated in FIG. 16 (S1007).

Next, the CPU 1001 notifies the print server 70 of the job cancellation via the network I/F 1006 and retracts the print job data being printed according to the operation of step S209 of the operation illustrated in FIG. 16 (S1008).

Next, the CPU 1001 determines whether or not the discharge of the sheet being conveyed has been completed up to the last page (S1009).

In a case where the discharge of the sheet being conveyed has not been completed up to the last page (step S1009: No), the CPU 1001 repeats the processing of step S1009.

On the other hand, in a case where the discharge of the sheet being conveyed has been completed up to the last page (step S1009: Yes), the CPU 1001 executes the remaining sheet detection control processing according to the operation of step S301 of the operation of FIG. 16 (S1010). The remaining sheet detection control processing is described below.

Next, the CPU 1001 determines whether or not there is no remaining sheet (S1011).

In a case where there is a remaining sheet and a notification that the remaining sheet has been detected is received in the remaining sheet detection control processing (step S1011: No), the CPU 1001 notifies a user of remaining sheet information and urges the user to remove the remaining sheet. Thereafter, the CPU 1001 returns to the processing of step S1010.

On the other hand, in a case where there is no remaining sheet and the notification that there is no remaining sheet is received in the remaining sheet detection control processing (step S1011: Yes), the CPU 1001 urges the print server 70 to re-input the print job (S1012).

Next, the CPU 1001 determines whether or not the print job has been re-input from the print server 70 (S1013).

In a case where the print job has not been re-input (step S1012: No), the CPU 1001 repeats the processing of step S1012.

On the other hand, in a case where the print job has been re-input (step S1012: Yes), the CPU 1001 returns to the processing of step S1002.

In a case where the misfed sheet has not been detected in the processing of step S1005 (step S1005: No), the CPU 1001 determines whether or not the sheet discharge has been completed up to the last page (S1014).

In a case where the sheet discharge has not been completed up to the last page (step S1014: No), the CPU 1001 returns to the processing of step S1006.

On the other hand, in a case where the sheet discharge has been completed up to the last page (step S1014: Yes), the CPU 1001 instructs to stop the misfed sheet detection control processing (S1015).

Next, the CPU 1001 instructs to stop the print head control processing (S1016), and then ends the operation.

### <Misfed Sheet Detection Control Processing>

The misfed sheet detection control processing executed by the image forming apparatus 10 according to the first embodiment of the present invention will be described in detail.

The misfed sheet detection control processing is processing of detecting whether or not there is a misfed sheet among the sheets being conveyed by the conveying portion 700 by using the optical sensor 210 of the printing portion 200. In the misfed sheet detection control processing, monitoring of the misfed sheet is continued until an instruction to stop the processing is issued, and a message signal of a misfed sheet detection notification is immediately transmitted when the misfed sheet is detected.

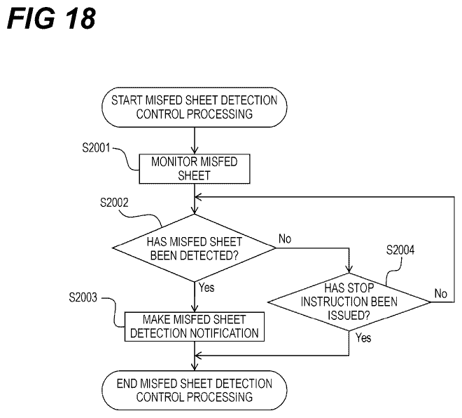

Next, the misfed sheet detection control processing will be described in more detail with reference to FIG. 18.

The misfed sheet detection control processing illustrated in FIG. 18 is started at a timing when the operation of step S1002 of the operation illustrated in FIG. 17 is started.

First, the CPU 1001 activates the optical sensor 210 in a case where the optical sensor 210 is not activated, and holds the optical sensor 210 in an activated state in a case where the optical sensor 210 is already activated. The CPU 1001 activates the optical sensor 210 to enable the optical sensor 210 to detect the misfed sheet, thereby performing the monitoring of the misfed sheet (S2001).

Next, the CPU 1001 determines whether or not the misfed sheet has been detected by the optical sensor 210 (S2002).

In a case where the misfed sheet has been detected (step S2002: Yes), the CPU 1001 makes the misfed sheet detection notification (S2003), and then ends the misfed sheet detection control processing.

On the other hand, in a case where the misfed sheet has not been detected by the optical sensor 210 (step S2002: No), the CPU 1001 determines whether or not an instruction to stop the misfed sheet detection control processing by the operation of step S1015 of the operation illustrated in FIG. 17 has been issued (S2004).

In a case where the stop instruction has not been issued (step S2004: No), the CPU 1001 returns to the processing of step S2002.

On the other hand, in a case where the stop instruction has been issued (step S2004: Yes), the CPU 1001 ends the misfed sheet detection control processing.

### <Print Head Control Processing>

The print head control processing executed by the image forming apparatus 10 according to the first embodiment of the present invention will be described in detail.

The print head control processing is processing of moving the inkjet head 201 to the printing position by the head controller 1010 when the printing operation starts, ejecting the ink onto the conveyed sheet from the inkjet head 201, and printing the image on the sheet. Furthermore, the print head control processing is processing of immediately moving and retracting the inkjet head 201 from the printing position to the retraction position by the head controller 1010 when the misfed sheet is detected in order to avoid the collision between the inkjet head 201 and the misfed sheet.

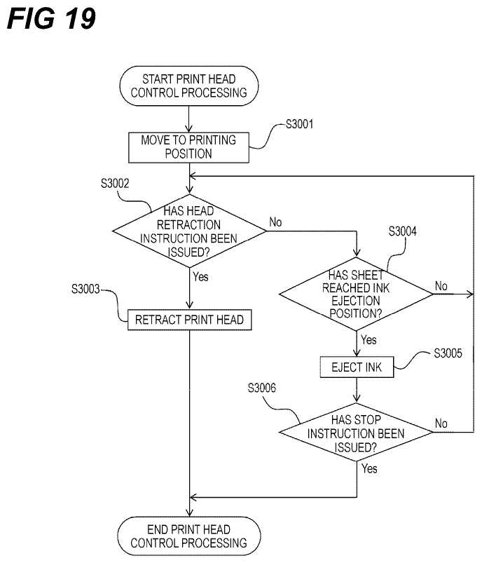

Next, the print head control processing will be described in more detail with reference to FIG. 19.

The print head control processing illustrated in FIG. 19 is started at a timing when the operation of step S1003 of the operation illustrated in FIG. 17 is started.

First, the CPU 1001 controls the head controller 1010 to move the inkjet head 201 to the printing position at which the ink can be ejected onto the sheet according to the operation of step S104 of the operation illustrated in FIG. 16 (S3001).

Next, the CPU 1001 determines whether or not an instruction to move the inkjet head 201 to the retraction position has been issued by the operation of step S1006 of the operation illustrated in FIG. 17 (S3002).

In a case where the instruction to move the inkjet head 201 to the retraction position has been issued (step S3002: Yes), the CPU 1001 controls the head controller 1010 to move and retract the inkjet head 201 to the retraction position (S3003). Thereafter, the CPU 1001 ends the print head control processing.

On the other hand, in a case where the instruction to move the inkjet head 201 to the retraction position has not been issued (step S3002: No), the CPU 1001 determines whether or not the sheet has reached an ink ejection position of the inkjet head 201 (S3004).

In a case where the sheet has not reached the ink ejection position (step S3004: No), the CPU 1001 returns to the processing of step S3002.

On the other hand, in a case where the sheet has reached the ink ejection position (step S3004: Yes), the CPU 1001 controls the head controller 1010 to cause the inkjet head 201 to eject the ink onto the sheet (S3005).

Next, the CPU 1001 determines whether or not an instruction to stop the print head control processing has been issued by the operation of step S1016 of the operation illustrated in FIG. 17 (S3006).

In a case where the instruction to stop the print head control processing has not been issued (step S3006: No), the CPU 1001 returns to the processing of step S3002.

On the other hand, in a case where the instruction to stop the print head control processing has been issued (step S3006: Yes), the CPU 1001 moves the inkjet head 201 to an initial position and ends the print head control processing.

### <Sheet Conveyance Control Processing>

The sheet conveyance control processing executed by the image forming apparatus 10 according to the first embodiment of the present invention will be described in detail.

The sheet conveyance control processing is processing of starting conveyance of the sheet fed from the sheet feeding portion 100 by rotating the conveying roller and executing the conveyance rerouting control processing in a case where an instruction to perform rerouting for changing the conveyance path due to detection of the misfed sheet is issued. Further, the sheet conveyance control processing is processing of notifying that the conveyance of all the sheets has been completed and stopping the conveying roller to end the conveyance of the sheet when the sheet discharge has been completed up to the sheet of the last page.

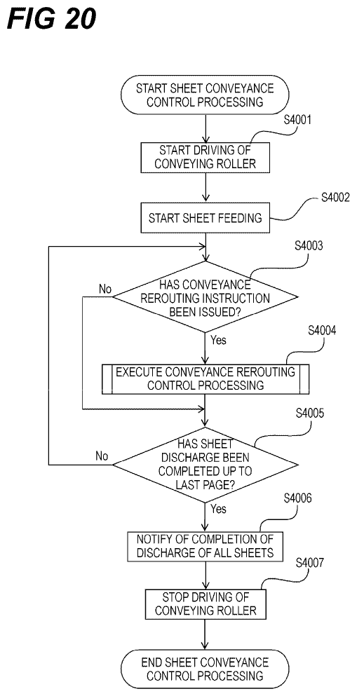

Next, the sheet conveyance control processing will be described in more detail with reference to FIG. 20.

The sheet conveyance control processing illustrated in FIG. 20 is started at a timing when the operation of step S1004 of the operation illustrated in FIG. 17 is started.

First, the CPU 1001 controls the conveyance controller 1011 to start driving of the conveying roller (S4001).

Next, the CPU 1001 controls the conveyance controller 1011 to cause the sheet feeding portion 100 to start sheet feeding (S4002).

Next, the CPU 1001 determines whether or not an instruction to reroute the subsequent sheet to the conveyance path for retracting the subsequent sheet to the sheet discharge destination has been issued by the operation of step S1007 of the operation illustrated in FIG. 16 (S4003).

In a case where the rerouting instruction has been issued (step S4003: Yes), the CPU 1001 executes the conveyance rerouting control processing (S4004). The conveyance rerouting control processing is described below.

Next, the CPU 1001 determines whether or not the sheet discharge has been completed up to the sheet of the last page (S4005).

In a case where the sheet discharge has not been completed up to the sheet of the last page (step S4005: No), the CPU 1001 returns to the processing of step S4003.

On the other hand, in a case where sheet discharge has been completed up to the sheet of the last page (step S4005: Yes), the CPU 1001 notifies that the discharge of all the sheets has been completed (S4006). Then, the CPU 1001 makes a conveyance rerouting completion notification by the operation of step S208 of the operation illustrated in FIG. 16 to notify that the conveyance rerouting control processing has been completed.

Next, the CPU 1001 controls the conveyance controller 1011 to stop the driving of the conveying roller (S4007), and then ends the sheet conveyance control processing.

On the other hand, in a case where the rerouting instruction has not been issued in step S4003 (step S4003: No), the CPU 1001 skips to the processing of step S4005.

### <Remaining Sheet Detection Control Processing>

The remaining sheet detection control processing executed by the image forming apparatus 10 according to the first embodiment of the present invention will be described in detail.

The remaining sheet detection control processing is processing for confirming whether or not an unexpected sheet remains on the conveyance path to confirm that the error recovery processing has been normally executed when the sheet being conveyed is retracted to the sheet discharge destination by the conveyance rerouting control processing caused by the detection of the misfed sheet. In the remaining sheet detection control processing, the conveying roller is driven for a predetermined time to confirm whether or not any of conveyance sensors has detected a sheet remaining on the conveyance path. In the remaining sheet detection control processing, in a case where a sheet has been detected by the conveyance sensor, it is notified that the remaining sheet has been detected, and in a case where no sheet has been detected by the conveyance sensor, it is notified that there is no remaining sheet.

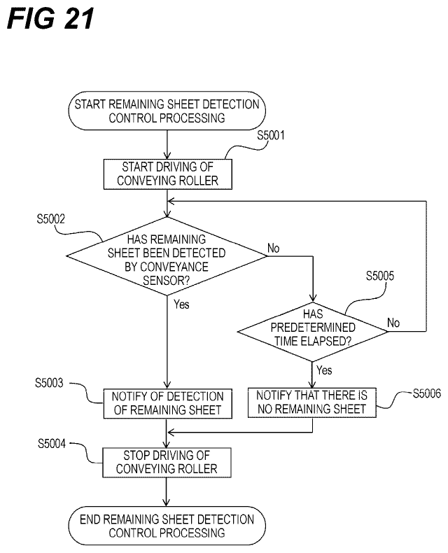

Next, the remaining sheet detection control processing will be described in more detail with reference to FIG. 21.

The remaining sheet detection control processing illustrated in FIG. 21 is started at a timing when an affirmative determination (Yes) is made in the processing of step S1009 of the operation illustrated in FIG. 17.

First, the CPU 1001 controls the conveyance controller 1011 to start driving of the conveying roller (S5001).

Next, the CPU 1001 determines whether or not a remaining sheet has been detected by the conveyance sensor (S5002).

In a case where a remaining sheet has been detected (step S5002: Yes), the CPU 1001 notifies that a remaining sheet has been detected (S5003).

Next, the CPU 1001 controls the conveyance controller 1011 to stop the driving of the conveying roller (S5004), and then ends the remaining sheet detection control processing.

On the other hand, in a case where remaining sheet has been not detected in step S5002 (step S5002: No), the CPU 1001 determines whether or not a predetermined time has elapsed from the detection of the misfed sheet (S5005).

In a case where the predetermined time has not elapsed (step S5005: No), the CPU 1001 returns to the processing of step S5002.

On the other hand, in a case where the predetermined time has elapsed (step S5005: Yes), the CPU 1001 notifies that there is no remaining sheet (S5006), and then executes the processing of step S5004.

After ending the remaining sheet detection control processing illustrated in FIG. 21, the CPU 1001 starts the operation of step S1011 of the operation illustrated in FIG. 17.

### <Conveyance Rerouting Control Processing>

The conveyance rerouting control processing executed by the image forming apparatus 10 according to the first embodiment of the present invention will be described in detail.

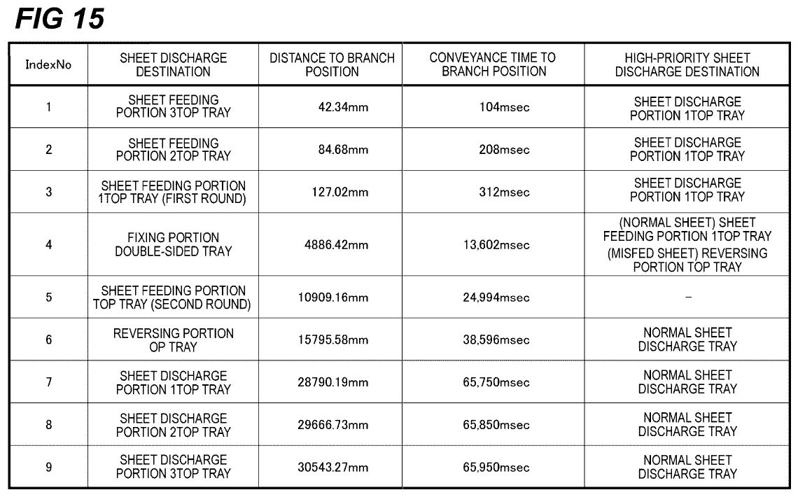

The conveyance rerouting control processing is processing of selecting and determining the sheet discharge destination according to a position where the sheet being conveyed is present on the conveyance path when the misfed sheet is detected, by using the sheet discharge destination management table illustrated as an example in FIG. 15. The conveyance rerouting control processing is processing of switching a conveyance destination so as to guide the sheet to a designated high-priority sheet discharge destination in a case where the high-priority sheet discharge destination is designated in the sheet discharge destination management table.

Here, the sheet discharge destination management table is a table that manages a plurality of sheet discharge destinations that can be used as the sheet retraction destinations when the misfed sheet is detected. The sheet discharge destination management table stores information of “IndexNo”, “sheet discharge destination”, “distance to branch position”, “conveyance time to branch position”, and “high-priority sheet discharge destination” in association with each other.

“IndexNo” is an identifier for uniquely identifying the sheet discharge destination. “Sheet discharge destination” indicates the sheet discharge destination. “Distance to branch position” indicates a distance to the branch position on the conveyance path for discharging the sheet to the associated sheet discharge destination with a sheet feeding position of the sheet feeding portion 100 as 0 mm. “Conveyance time to branch position” indicates a time required for movement to the branch position on the conveyance path for discharging the sheet to the associated sheet discharge destination at a predetermined conveyance speed with the sheet feeding start time from the sheet feeding portion 100 as 0 second.

In the sheet discharge destination management table illustrated in FIG. 15, a sheet feeding position Q (see FIG. 10) of the sheet feeding cassette 132 is 0 mm. Further, the branch position corresponding to the distance to the branch position and the conveyance time to the branch position of IndexNo. 1 is the branch position B1. The branch position corresponding to the distance to the branch position and the conveyance time to the branch position of IndexNo. 2 is the branch position B2. The branch position corresponding to the distances to the branch position and the conveyance times to the branch position of IndexNo. 3 and IndexNo. 5 is the branch position B3. The branch position corresponding to the distance to the branch position and the conveyance time to the branch position of IndexNo. 4 is the branch position B4.

Further, the branch position corresponding to the distance to the branch position and the conveyance time to the branch position of IndexNo. 6 is the branch position B5. The branch position corresponding to the distance to the branch position and the conveyance time to the branch position of IndexNo. 7 is the branch position B6. The branch position corresponding to the distance to the branch position and the conveyance time to the branch position of IndexNo. 8 is the branch position B7. The branch position corresponding to the distance to the branch position and the conveyance time to the branch position of IndexNo. 9 is the branch position B8.

As for the sheet discharge destination of the sheet discharge destination management table, the sheet feeding portion 3TOP tray 134 is the sheet discharge destination of sheet discharge through the sheet discharge port 133, the sheet feeding portion 2TOP tray 124 is the sheet discharge destination of sheet discharge through the sheet discharge port 123, and the sheet feeding portion 1TOP tray 114 is the sheet discharge destination of sheet discharge through the sheet discharge port 113. Further, the fixing portion double-sided tray 302 is the sheet discharge destination of sheet discharge through the sheet discharge port 301, and the reversing portion TOP tray 502 is the sheet discharge destination of sheet discharge through the sheet discharge port 501. Further, the sheet discharge portion 1TOP tray 613 is the sheet discharge destination of sheet discharge through the sheet discharge port 612, the sheet discharge portion 2TOP tray 623 is the sheet discharge destination of sheet discharge through the sheet discharge port 622, and the sheet discharge portion 3TOP tray 633 is the sheet discharge destination of sheet discharge through the sheet discharge port 632.

In the sheet discharge destination management table illustrated in FIG. 15, the sheet discharge destination for the sheet present upstream of the sheet discharge portion 1TOP tray 613 in the conveyance direction when the misfed sheet is detected is the sheet discharge portion 1TOP tray 613. In the sheet discharge destination management table illustrated in FIG. 15, the sheet discharge destination for the sheet present between the sheet discharge portion 1TOP tray 613 and the sheet discharge portion 2TOP tray 623 when the misfed sheet is detected is the sheet discharge portion 2TOP tray 623. Further, in the sheet discharge destination management table illustrated in FIG. 15, the sheet discharge destination for the sheet present between the sheet discharge portion 2TOP tray 623 and the sheet discharge portion 3TOP tray 633 when the misfed sheet is detected is the sheet discharge portion 3TOP tray 633.

On the other hand, in the sheet discharge destination management table illustrated in FIG. 15, the high-priority sheet discharge destination for the sheet being conveyed between the sheet feeding cassette 132 and the branch position B3 to the sheet discharge portion 1TOP tray 613 when the misfed sheet is detected is the sheet discharge portion 1TOP tray 613. As a result, the image forming apparatus 10 can collectively discharge, to the same sheet discharge portion 1TOP tray 613, the sheets being conveyed between the sheet feeding cassette 132 and the branch position to the sheet discharge portion 1TOP tray 613.

Further, in the sheet discharge destination management table illustrated in FIG. 15, the fixing portion double-sided tray 302 is set as the sheet discharge destination of the sheet present in a range between the branch position B3 to the sheet discharge portion 1TOP tray 613 and the branch position B4 to the fixing portion double-sided tray 302 when the misfed sheet is detected. However, the misfed sheet and the normal sheet present in the range between the branch position B3 to the sheet discharge portion 1TOP tray 613 and the branch position B4 to the fixing portion double-sided tray 302 are desirably discharged to different sheet discharge destinations. Therefore, in the sheet discharge destination management table illustrated in FIG. 7, the high-priority sheet discharge destination of the misfed sheet present in the range between the branch position B3 to the sheet discharge portion 1TOP tray 613 and the branch position B4 to the fixing portion double-sided tray 302 is set to the reversing portion TOP tray 502.

In the sheet discharge destination management table illustrated in FIG. 15, the high-priority sheet discharge destination of the normal sheet present in the range between the branch position B3 to the sheet discharge portion 1TOP tray 613 and the branch position B4 to the fixing portion double-sided tray 302 is set to the sheet feeding portion 1TOP tray 114.

Since the normal sheet present in the range between the branch position B3 to the sheet discharge portion 1TOP tray 613 and the branch position B4 to the fixing portion double-sided tray 302 has passed through the printing portion 200 once, the image is printed only on the front side. The sheet on which the image has been printed only on the front side other than the normal sheet present in the range between the branch position B3 to the sheet discharge portion 1TOP tray 613 and the branch position B4 to the fixing portion double-sided tray 302 is also present downstream of the branch position B4 to the fixing portion double-sided tray 302 in the conveyance direction. In the sheet discharge destination management table illustrated in FIG. 15, the high-priority sheet discharge destination of the normal sheet on which the image has been printed only on the front side and which is present downstream of the branch position B4 in the conveyance direction is set to the same sheet feeding portion 1TOP tray 114 as that for the normal sheet present upstream of the branch position B4 in the conveyance direction.

Only the normal sheet on which the image has been printed on both of the front side and the back side is present downstream of the branch position B3 to the sheet feeding portion 1TOP tray 114 in the second round in the conveyance direction. Therefore, there is no problem even if the normal sheet present downstream of the branch position B3 to the sheet feeding portion 1TOP tray 114 in the second round in the conveyance direction is discharged as usual, and it is not necessary to switch the sheet discharge destination. Accordingly, in the sheet discharge destination management table illustrated in FIG. 15, the high-priority sheet discharge destination of the normal sheet present downstream of the branch position B3 to the sheet feeding portion 1TOP tray 114 in the second round in the conveyance direction is set to a normal sheet discharge tray. Here, the normal sheet discharge tray is the discharged sheet stacker 611, the discharged sheet stacker 621, or the discharged sheet stacker 631.

The sheet discharge destination management table is set and stored in advance for each of the sheet feeding cassettes 110 to 112, 120 to 122, and 130 to 132. In the present embodiment, a description of an example of the sheet discharge destination management table set corresponding to each of the sheet feeding cassettes 110 to 112, 120 to 122, 130, and 131 other than the sheet feeding cassette 132 is omitted.

The sheet discharge destination management table illustrated in FIG. 15 as an example is used at the time of the double-sided printing in which the image is printed on both sides of the sheet as illustrated in FIGS. 10 to 14. On the other hand, in the case of the single-sided printing in which the image is printed only on the front side of the sheet as illustrated in FIGS. 5 to 9, the sheet discharge destination management table different from the sheet discharge destination management table illustrated in FIG. 15 is used. In the sheet discharge destination management table in this case, the fixing portion double-sided tray 302 is not used.

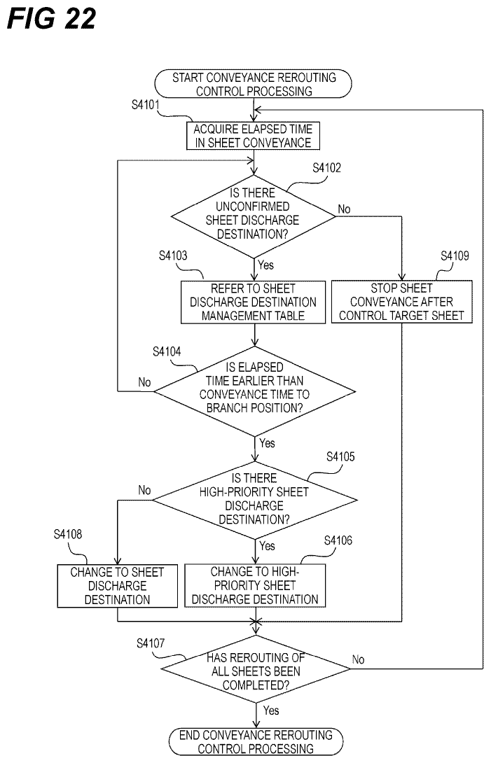

Next, the conveyance rerouting control processing will be described in more detail with reference to FIGS. 15 and 22.

The conveyance rerouting control processing illustrated in FIG. 22 is started at a timing when an affirmative determination (Yes) is made in the processing of step S4003 of the sheet conveyance control processing illustrated in FIG. 20.

First, the CPU 1001 acquires an elapsed time from the sheet feeding start time of the sheet that is a rerouting control target by the sheet feeding portion 100 to the current time (hereinafter, referred to as the “elapsed time from the sheet feeding start time”) (S4101).

Next, the CPU 1001 determines whether or not there is a sheet discharge destination that is not referred to in the sheet discharge destination management table (S4102). At this time, the CPU 1001 determines whether or not there is a sheet discharge destination that is not referred to in order from IndexNo. 1.

In a case where there is a sheet discharge destination that is not referred to (step S4102: Yes), the CPU 1001 refers to the sheet discharge destination that is not referred to in the sheet discharge destination management table (S4103).

Next, the CPU 1001 compares the elapsed time from the sheet feeding start time acquired in step S4101 with “conveyance time to branch position” being referred to in the sheet discharge destination management table. Then, the CPU 1001 determines whether or not the elapsed time from the sheet feeding start time acquired in step S4101 is earlier than “conveyance time to branch position” being referred to (S4104). In this manner, the CPU 1001 determines a position of the sheet that is the sheet discharge control target by using the elapsed time from the sheet feeding start time.

In a case where the acquired elapsed time from the sheet feeding start time is after “conveyance time to branch position” being referred to (step S4104: No), the CPU 1001 advances IndexNo that is being referred to in the sheet discharge destination management table by one, and returns to the processing of step S4102.

On the other hand, in a case where the acquired elapsed time from the sheet feeding start time is earlier than “conveyance time to branch position” being referred to (step S4104: Yes), the CPU 1001 determines whether or not the high-priority sheet discharge destination is associated with the sheet discharge destination being referred to (S4105).

In a case where the high-priority sheet discharge destination is associated with the sheet discharge destination associated with IndexNo being referred to (step S4105: Yes), the CPU 1001 changes the conveyance path such that the sheet that is the sheet discharge control target is discharged to the associated high-priority sheet discharge destination (S4106). For example, in a case where IndexNo. 3 is referred to, the CPU 1001 changes the conveyance path such that the sheet that is the sheet discharge control target is discharged to the “sheet discharge portion 1TOP tray 613” that is the high-priority sheet discharge destination associated with IndexNo. 3. As described above, in a case where the sheet can be discharged to the high-priority sheet discharge destination, the CPU 1001 discharges the sheet that is the sheet discharge control target to the associated high-priority sheet discharge destination.

Here, the high-priority sheet discharge destination is the sheet discharge destination that has a short downtime at the time of completion of sheet discharge and is designated for collective sheet discharge for each printing state in which the sheet that is the sheet discharge control target is the misfed sheet, the normal sheet whose both sides are blank, or the normal sheet on which the image has been printed only on the front side.

As described above, the CPU 1001 calculates the sheet discharge destination to be selected as the sheet discharge destination according to the position of the sheet that is the sheet discharge control target on the conveyance path when the misfed sheet is detected by referring to the sheet discharge destination management table.

Next, the CPU 1001 determines whether or not rerouting of all the sheets being conveyed has been completed (S4107).

In a case where the rerouting of all the sheets being conveyed has been completed (step S4107: Yes), the CPU 1001 ends the conveyance rerouting control processing.

On the other hand, in a case where the rerouting of all the sheets being conveyed has not been completed (step S4107: No), the CPU 1001 returns to the processing of step S4101.

In addition, in a case where the high-priority sheet discharge destination is not associated with the sheet discharge destination being referred to in the processing of step S4105 (step S4105: No), the CPU 1001 changes the conveyance path such that the sheet that is the sheet discharge control target is discharged to the sheet discharge destination being referred to (S4108). Thereafter, the CPU 1001 executes the processing of step S4107. As a result, the CPU 1001 discharges the subsequent sheet present within a predetermined range specified by the elapsed time from the sheet feeding start time when the misfed sheet is detected to the closest sheet discharge destination positioned downstream of the predetermined range in the conveyance direction by using the sheet discharge destination management table.

In addition, in a case where there is no sheet discharge destination that is not referred to in the processing of step S4102 (step S4102: No), the CPU 1001 determines that there is no sheet discharge destination and stops conveyance of all the sheets conveyed after the sheet that is the sheet discharge control target (S4109). A case where there is no sheet discharge destination that is not referred to means a case where the sheet has passed through the branch positions to all the sheet discharge destinations. Thereafter, the CPU 1001 executes the processing of step S4107.

By executing the conveyance rerouting control processing, it is possible to select the sheet discharge destination closest to the sheet being conveyed based on the elapsed time from the sheet feeding start time of the subsequent sheet when the misfed sheet is detected. In addition, by referring to the sheet discharge destination management table, it is possible to implement control to switch the sheet discharge destination including the sheet discharge destination to be preferentially selected as the temporary retraction destination of the subsequent sheet according to the position where the sheet that is the sheet discharge control target is present when the misfed sheet is detected.

In the present embodiment, the subsequent sheet is discharged to the sheet discharge destination such as the sheet feeding portion 1TOP tray 114, the sheet feeding portion 2TOP tray 124, the sheet feeding portion 3TOP tray 134, or the fixing portion double-sided tray 302 according to the position of the subsequent sheet when the abnormality is detected by the optical sensor 210. As a result, when the abnormality of the sheet conveyed to the printing portion 200 is detected, it is possible to reduce the downtime for discharging and temporarily retracting the subsequent sheet conveyed after the misfed sheet.

### Second Embodiment

A configuration of an image forming apparatus according to a second embodiment of the present invention is the same as those in FIGS. 1 and 2, and thus a description thereof will be omitted. In addition, since an operation based on software of the image forming apparatus according to the present embodiment is the same as the operation illustrated in FIG. 16, a description thereof will be omitted. Furthermore, since an operation other than conveyance rerouting control processing in an operation of hardware of the image forming apparatus according to the present embodiment is the same as that in FIG. 17, a description of the operation other than the conveyance rerouting control processing will be omitted.

### <Conveyance Rerouting Control Processing>

The conveyance rerouting control processing executed by the image forming apparatus according to the second embodiment of the present invention will be described in detail.

The conveyance rerouting control processing according to the present embodiment is processing in which a CPU 1001 determines a printing state of a sheet according to the number of times the sheet that is a sheet discharge control target has passed through a printing portion 200, and dynamically determines a sheet discharge destination according to the determined printing state.

In the conveyance rerouting control processing according to the present embodiment, the misfed sheet is discharged to a specific sheet discharge destination. In addition, the number of times the sheet has passed through the printing portion 200 is determined by comparing an elapsed time from a sheet feeding start time of the sheet that is the sheet discharge control target with a time required for the sheet to pass through the printing portion 200 once from the sheet feeding start time and a time required for the sheet to pass through the printing portion 200 twice. At this time, time information regarding the time required for the sheet to pass through the printing portion 200 once from the sheet feeding start time and the time required for the sheet to pass through the printing portion twice is stored in a ROM 1003 in advance. As a result, a position of the sheet that is the sheet discharge control target can be estimated from the elapsed time from the sheet feeding start time.

Specifically, in a case where the elapsed time from the sheet feeding start time of the sheet that is the sheet discharge control target is equal to or shorter than the time required for the sheet to pass through the printing portion 200 once, the number of times the sheet has passed through the printing portion 200 is determined to be 0 times. In addition, in a case where the elapsed time from the sheet feeding start time of the sheet that is the sheet discharge control target is longer than the time required for the sheet to pass through the printing portion 200 once and is equal to or shorter than the time required for the sheet to pass through the printing portion 200 twice, the number of times the sheet has passed through the printing portion 200 is determined to be one time. Furthermore, in a case where the elapsed time from the sheet feeding start time of the sheet that is the sheet discharge control target is longer than the time required for the sheet to pass through the printing portion 200 twice, the number of times the sheet has passed through the printing portion 200 is determined to be two times.

Further, the sheet discharge destination with the shortest downtime is selected according to the position of the sheet that is the sheet discharge control target. Specifically, the misfed sheet is discharged to a reversing portion TOP tray 502, and the normal sheet that has passed through the printing portion 200 0 times is discharged to a sheet discharge portion 1TOP tray 613 positioned at the closest position. In addition, the normal sheet that has passed through the printing portion 200 once is discharged to a sheet feeding portion 1TOP tray 114 positioned at the closest position, and the normal sheet that has passed through the printing portion 200 twice is discharged to a normal sheet discharge destination.

The sheet discharge destination is not limited to the above, and can be changed to the sheet discharge destination from which a user can easily reuse the retracted normal sheet according to a conveyance path configuration of an image forming apparatus 10 such as a configuration additionally including an inspection machine or a finisher. Depending on the configuration of the apparatus, the sheet discharge destination may be switched for each process such as an image forming process, a fixing process, a cooling process, and a reversing process for the sheet.

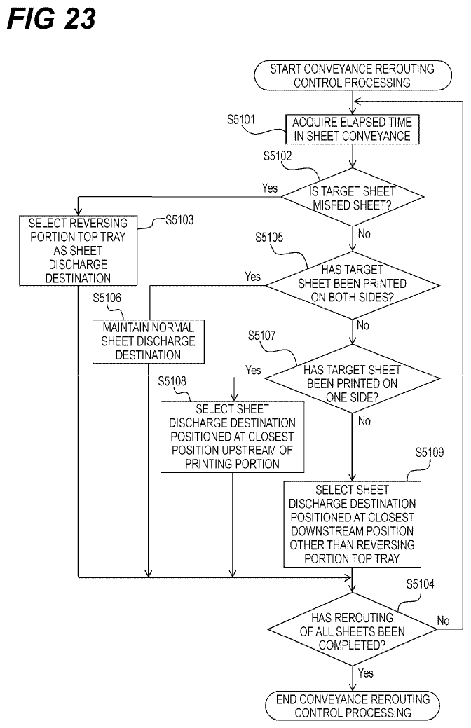

Subsequently, the conveyance rerouting control processing according to the present embodiment will be described in more detail with reference to FIG. 23.

The conveyance rerouting control processing illustrated in FIG. 23 is started at a timing when an affirmative determination (Yes) is made in the processing of step S4003 of the sheet conveyance control processing illustrated in FIG. 20.

First, the CPU 1001 acquires the elapsed time from the sheet feeding start time of the sheet that is the sheet discharge control target (S5101).

Next, the CPU 1001 determines whether or not the sheet that is the sheet discharge control target is the misfed sheet (S5102).

In a case where the sheet is the misfed sheet (step S5102: Yes), the CPU 1001 controls a conveyance controller 1011 to change a conveyance path such that the misfed sheet is discharged to the reversing portion TOP tray 502 (S5103).

Next, the CPU 1001 determines whether or not rerouting of all the sheets being conveyed has been completed (S5104).

In a case where the rerouting of all the sheets being conveyed has been completed (S5104: Yes), the CPU 1001 ends the conveyance rerouting control processing.

On the other hand, in a case where the rerouting of all the sheets being conveyed has not been completed (step S5104: No), the CPU 1001 returns to the processing of step S5101.

In addition, in a case where the sheet is not the misfed sheet in the processing of step S5102 (step S5102: No), the CPU 1001 determines whether or not the image has been printed on both sides of the sheet that is the sheet discharge control target (the sheet has been printed on both sides) (S5105). At this time, the CPU 1001 determines whether or not the elapsed time from the sheet feeding start time of the sheet that is the sheet discharge control target acquired in the processing of step S5101 is longer than the time required for the sheet to pass through the printing portion 200 twice.

In a case where the image has been printed on both sides (step S5105: Yes), the CPU 1001 selects a sheet discharge port through which the sheet is to be discharged to the normal sheet discharge destination (S5106). In this case, the CPU 1001 determines that the image has been printed on both sides of the sheet that is the sheet discharge control target based on the longer elapsed time from the sheet feeding start time than the time required for the sheet to pass through the printing portion 200 twice. Thereafter, the CPU 1001 executes the processing of step S5104.

In a case where the image has not been printed on both sides (step S5105: No), the CPU 1001 determines whether or not the image has been printed only on the front side of the sheet that is the sheet discharge control target (the sheet has been printed on one side) (S5107). In this case, the CPU 1001 determines that the image has not been printed on both sides of the sheet that is the sheet discharge control target based on the elapsed time from the sheet feeding start time, the elapsed time being equal to or shorter than the time required for the sheet to pass through the printing portion 200 twice. In addition, the CPU 1001 determines whether or not the image has been printed only on the front side of the sheet that is the sheet discharge control target by determining whether or not the elapsed time from the sheet feeding start time is longer than the time required for the sheet to pass through the printing portion 200 once.

In a case where the image has been printed only on the front side (step S5107: Yes), the CPU 1001 changes the conveyance path such that the sheet that is the control target is discharged to the sheet feeding portion 1TOP tray 114 positioned at the closest position (S5108). In this case, the CPU 1001 determines that the image has been printed only on the front side of the sheet that is the sheet discharge control target based on the longer elapsed time from the sheet feeding start time than the time required for the sheet to pass through the printing portion 200 once. Thereafter, the CPU 1001 executes the processing of step S5104.

In a case where both sides are blank (step S5107: No), the CPU 1001 changes the conveyance path such that the sheet that is the sheet discharge control target is discharged to the sheet feeding portion 1TOP tray 114 positioned at the closest downstream position in the conveyance direction other than the reversing portion TOP tray 502 (S5109). In this case, since the image has not been printed on both sides and the image has not been printed only on the front side, the CPU 1001 determines that both sides of the sheet that is the sheet discharge control target are blank. Thereafter, the CPU 1001 executes the processing of step S5104.

As described above, control of dynamically switching the sheet discharge destination according to the position where the sheet that is the control target is present is implemented by executing the conveyance rerouting control processing.

In the present embodiment, a blank state, a single-sided printing state, or a double-sided printing state is determined based on the number of times the conveyed sheet has passed through the printing portion 200. As a result, in the present embodiment, the effects of the first embodiment described above can be achieved, and a sheet discharge destination management table can be made unnecessary, and a simple configuration can be achieved.

It goes without saying that the present invention is not limited to the above-described embodiments, and various modifications can be made without departing from the gist of the present invention.

In the first and second embodiments described above, the subsequent sheet present in a range specified by the elapsed time from the sheet feeding start time is discharged to the closest sheet discharge destination that is downstream of the specified range in the conveyance direction. However, the present invention is not limited thereto, and the subsequent sheet present in a range for each of the image forming process, the fixing process, the cooling process, and the reversing process may be discharged to the closest sheet discharge destination that is downstream of the range for each process in the conveyance direction. Alternatively, the subsequent sheet present in a range of each unit of the sheet feeding portion 100, the printing portion 200, the fixing portion 300, the cooling portion 400, the reversing portion 500, and the sheet discharge portion 600 may be discharged to the closest sheet discharge destination that is downstream of the range of each unit in the conveyance direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-207614, filed Dec. 8, 2023, which is hereby incorporated by reference herein in its entirety.

What is claimed is:

1. An inkjet recording apparatus comprising:
an accommodating portion configured to accommodate a sheet;
a feeding portion configured to feed the sheet accommodated in the accommodating portion;
a conveying portion configured to convey the sheet fed by the feeding portion;
an ink head portion configured to eject ink onto the sheet conveyed by the conveying portion to form an image;
a detector provided downstream of the feeding portion and upstream of the ink head portion in a conveyance direction of the sheet and configured to detect the sheet;
a first stack tray provided upstream of the detector in the conveyance direction and on which the sheet conveyed by the conveying portion is stacked;
a second stack tray provided downstream of the ink head portion in the conveyance direction and on which the sheet conveyed by the conveying portion is stacked; and
a controller configured to control the conveying portion such that the sheet detected by the detector passes through the ink head portion without forming the image and is discharged to the second stack tray, and control the conveying portion such that a subsequent sheet that is fed by the feeding portion and follows the sheet detected by the detector is discharged to the first stack tray without passing through the ink head portion, based on a detection result of the detector.

2. The inkjet recording apparatus according to claim 1, wherein the detector detects uplift or a fold of the sheet.

3. The inkjet recording apparatus according to claim 1, wherein the detector detects a length of the sheet in a width direction orthogonal to the conveyance direction.

4. The inkjet recording apparatus according to claim 1, wherein the sheet that has passed through a branch path branched upstream of the detector is stacked on the first stack tray.

5. The inkjet recording apparatus according to claim 1, further comprising a third stack tray on which a preceding sheet that is downstream of the sheet detected by the detector in the conveyance direction is stacked.

6. The inkjet recording apparatus according to claim 1, wherein subsequent sheets after a predetermined number of sheets detected by the detector are discharged to the first stack tray.

7. The inkjet recording apparatus according to claim 1, wherein
a plurality of the first stack trays are provided, and
the subsequent sheet following the sheet detected by the detector is discharged to the closest first stack tray when the sheet is detected by the detector.

8. The inkjet recording apparatus according to claim 1, wherein the controller performs control such that the sheet retained on a double-sided conveyance path is discharged to the second stack tray or a stack tray other than the second stack tray in a case where the image is formed on both sides of the sheet.
